(19) United States
(12) Patent Application Publication
(10) Pub. No.: US 2014/0315170 A1
(43) Pub. Date: Oct. 23, 2014

(54) Apparatus, System, and Method to Promote Behavior Change Based on Mindfulness Methodologies

(71) Applicant: Proteus Digital Health, Inc., Redwood City, CA (US)

(72) Inventors: Arna Diana Ionescu, San Francisco, CA (US); Nancy Dougherty, San Mateo, CA (US)

(21) Appl. No.: 14/359,849

(22) PCT Filed: Nov. 21, 2012
(86) PCT No.: PCT/US2012/066399

§ 371 Date: May 21, 2014

Related U.S. Application Data
(60) Provisional application No. 61/563,449, filed on Nov. 23, 2011.

(51) Int. Cl. G09B 5/02

(52) U.S. Cl. CPC G09B 5/02
USPC 434/236

(57) ABSTRACT

System, method, and article to prompt behavior change based on a mindfulness methodology are provided. Various aspects of the system include mindfulness promotion data generated and/or communicated from/to a device; a methodology module associated with software/processor to identify at least one behavior change methodology associated with the mindfulness promotion data; and an instruction module associated with a software/processor to initiate the identified at least one behavior change methodology.

### CROSS REFERENCE TO RELATED APPLICATIONS

This application claims priority to U.S. Application Ser. No. 61/563,449 dated Nov. 23, 2011 entitled Apparatus, System and Method to Promote Behavior Change Based on Mindfulness Methodologies, which is incorporated herein, in its entirety.

### TECHNICAL FIELD

The present disclosure relates generally to the technical fields of health-related devices and communications. More specifically, and in various illustrative aspects, the present disclosure relates to an apparatus, system, and method to promote behavior change based on mindfulness.

### INTRODUCTION

Lack of adherence to medication and other health regimens may pose significant issues. Many individuals may fail to engage in behaviors necessary to sustain adherence to therapies, nutritional programs, and emotional wellness programs, among others. Traditional mental models such as physician instruction, long-term health rewards, and management of disease conditions simply fail to support sustained adherence to the therapies. Such mental models may be quite abstract and difficult to conceive. Individuals may not identify with abstractions such as, “If I take this pill every day for the next ten years, I may live longer.” Failure to adhere to therapies may result in unnecessary disease progression, wasted medical resources, and other untoward outcomes.

What is needed, then, is a set of motivators capable of promoting sustained behavior change that may be associated with various improved outcomes. More particularly, what is needed is a set of motivators using ingestible products to promote mindfulness and behavior change by leveraging several psychological and technological mechanisms.

### SUMMARY

The present disclosure provides various apparatus, systems, and methods to promote behavior change based on mindfulness. Various aspects include mechanisms for sustaining behavior change in consumers. Such behavior changes may have many and varied positive results, e.g., improved treatment outcomes, broad social usage, charitable benefits to others, etc. The apparatus, systems, and methods have broad applicability across consumer populations, disease states, geographical territories, and interested stakeholders.

### BRIEF DESCRIPTION OF THE FIGURES

FIG. 1 shows a schematic of one aspect of a system to prompt behavior change based on a mindfulness methodology.

FIG. 2A shows one aspect of a system operation of the system to prompt behavior change in FIG. 1.

FIG. 2B illustrates one aspect of a conceptualization of a mindfulness methodology.

FIG. 3 illustrates one aspect of a mindfulness ingestible device dispensing apparatus.

FIG. 4 illustrates one aspect of a mindfulness ingestible device dispensing apparatus.

FIG. 5 illustrates a graphical representation of the results of a mindfulness experiment.

FIG. 6 illustrates one conceptualization of a mood miner methodology.

FIG. 7 illustrates one conceptualization of a help from my friends methodology.

FIG. 8 illustrates one conceptualization of a commit to healthy eating methodology.

FIG. 9 illustrates one conceptualization of a matched methodology.

FIG. 10 illustrates a method of prompting behavior change.

FIG. 11 is a block diagram representation of one aspect of the event indicator system with dissimilar metals positioned on opposite ends.

FIG. 12 is a block diagram representation of another aspect of the event indicator system with dissimilar metals positioned on the same end and separated by a non-conducting material.

FIG. 13 shows ionic transfer or the current path through a conducting fluid when the event indicator system of FIG. 11 is in contact with conducting liquid and in an active state.

FIG. 14A shows an exploded view of the surface of dissimilar materials of FIG. 13.

FIG. 14B shows the event indicator system of FIG. 13 with a PH sensor unit.

FIG. 15 is a block diagram illustration of one aspect of the control device used in the system of FIGS. 11 and 12.

FIG. 16 is a functional block diagram of a demodulation circuit that performs coherent demodulation that may be present in a receiver, according to one aspect.

FIG. 17 illustrates a functional block diagram for a beacon module within a receiver, according to one aspect.

FIG. 18 is a block diagram of different functional modules that may be present in a receiver, according to one aspect.

FIG. 19 is a block diagram of a receiver, according to one aspect.

FIG. 20 provides a block diagram of a high frequency signal chain in a receiver, according to one aspect.

FIG. 21 provides a diagram of how a system that includes a signal receiver and an ingestible event marker may be employed, according to one aspect.

### DETAILED DESCRIPTION

The present disclosure provides multiple aspects of an apparatus, system, and method to promote behavior change based on mindfulness. As described hereafter in more detail, a system and method of the present disclosure may be used to prompt sustainable behavior changes with various beneficial results. The results, for example, may include improved treatment outcomes, broad social usage, beneficial donations to various recipients, prudent use of medical resources, etc.

In various aspects, mindfulness refers to the emotional mindfulness (in the Buddhist meditation sense, for example), which has been proven to be very effective in increasing positive emotions, combating stress and depression, and more. The term mindfulness also refers to be aware and mindful in all activities and movements both physical and mental.

In one aspect, the present disclosure is directed to ingestible products to promote mindfulness and behavior change by leveraging several psychological and technological mechanisms. In the illustrated aspects, the apparatus, system, and method according to the present disclosure may be referred to herein as the mindfulness methodology.

In various aspects, the present disclosure provides various aspects of a mindfulness methodology comprising one or more of the following components. In one aspect, the individual identifies a desire or need for mindfulness, either by purchasing a mindfulness pre-made system, or personally choosing the meaning ascribed to the ingestible products to tailor the system to specific needs. In another aspect, the individual attaches meaning to the ingestible products through means such as labeling, packaging, and coloring, among other techniques. This can be done either as part of the product or by the individual, for example. In another aspect, the individual maintains mindfulness to identify when to ingest a mindfulness ingestible product, and selects which mindfulness ingestible product is needed. In another aspect, the individual may experience an immediate psychological benefit from taking the mindfulness ingestible product. For example, from a placebo effect, an effect of mindfulness, an effect of having a mindset shift towards being aware of one's own control over the mindfulness situation, etc. In another aspect, the system may provide an optional response. For example, the system may know when a mindfulness ingestible product is ingested and what meaning was ascribed to the mindfulness ingestible product. The system can respond in a variety of ways, from contacting the individual's social network, contacting the individual directly, making changes to the individual's environment, making data contributions to a tracking system, etc. In another aspect, analytics may be employed on long term data to help the individual gain insight into their behaviors, possibly add predictive and intervention technologies. The biometric data gathered during use of the mindfulness methodology would be especially useful here.

As used herein a “placebo pills” mindfulness methodology provides a system of “intention pills” e.g., placebos, vitamins, etc. that serve as an indicator or reminder of an individual's intent, commitment, etc. The intention pill may be ingested as an individual program, as part of group participation, an empathy relay, a treatment simulation pill, etc. To illustrate, an individual may commit to ingesting, and ingest, a placebo each time a friend has to ingest a prescribed medication for a treatment regimen. The commitment to “co-ingest” and the act of solidarity both shows a real support of the friend's plight and progress as well as helps the individual offer continual support to the friend.

The intention pill may trigger things to change for the individual, make intentions of the individual tangible to them and others, make the individual feel empowered, enable the individual to reach their goal, etc. Group participation may permit the individual to feel as if they are part of a bigger cause, e.g., group invitation, reinforce the individual's reason(s) for participating, and help the individual connect to like-minded people. The empathy relay may provide support for an individual's friend, give the individual something to do for a friend, show the individual's support, offer continual support for the friend, etc. The treatment simulation pill may assist the individual in avoiding behavior, choices, etc., that worsen the individual's condition, assist the individual in experiencing the ramification of a treatment regimen in their life, give the individual a reason to change their behavior to avoid potential consequences associated with foregoing a behavior change, etc. The placebo pills methodology may enhance behavior changes, etc., for persons.

Examples of implementation include generation of mindfulness promotion data, e.g., ingestion event data. The mindfulness promotion data are communicated to a website associated with the methodology module. The methodology module may process the mindfulness promotion data to identify the corresponding commit to healthy eating methodology. The instruction module may initiate an instruction whereby program(s) and associated system(s) generate comments on social media such as Facebook or Twitter relevant to the commitment, generate timely and meaningful reminders, and, upon predetermined conditions, post celebratory comments on Facebook regarding the accomplishment, send a tweet on Twitter, send a Facebook “like,” send a text message such as a short message service (SMS) message or multimedia message service (MMS) message, and/or send an email.

It will be appreciated that based on current studies, such as an irritable bowel syndrome (IBS) study, the placebo effect has been to work even when labeled as placebos (placebos without deception). According to a recent study of individuals with irritable bowel syndrome, the placebo effect worked almost as well as the leading medication on the market. This was found to be true even when the individuals were informed that the medication they were taking was a “fake” otherwise known as a placebo. Researchers were surprised that the placebo seemed to work for many of the individuals even though the individuals were aware that the medication was a placebo. In fact, according to the study, it was made absolutely clear to the individuals that the placebo medication contained no active ingredient and was made from inert substances and the term “placebo” was actually printed on the bottle. The individuals were even told not to believe in the placebo effect and to just ingest the medication. See for example, the article posted on the world-wide-web site: cbsnews.com/8301-504763_{—}162-20026483-10391704.html. For convenience and clarity, as used herein, the term medication may be used to describe active pharmaceuticals, prescription or over the counter drugs, vitamins, as well as placebos, without limitations.

In various aspects, the mindfulness methodology may comprise the use of emotionally-based mindfulness pills (e.g., willpower, happiness), or other mindfulness pills based on specific individual desires, such as dieting, where pills would both help track food intake and make individuals more aware and conscientious of their eating habits. In addition, biometric data can be used both to understand the individual's physical state surrounding specific mindfulness events, and to provide feedback to help individuals regulate. For example, an individual can be shown the correlations between sleep or exercise patterns and emotional regulation. The mindfulness methodology also may comprise a rich interface with meaningful displays, interactive or adaptive goal setting, and social components to further motivate mindfulness and behavior change, as described in more detail hereinbelow.

Broadly speaking, various aspects of the mindfulness methodology comprises various systems and methods coupled with devices, e.g., ingestible devices, processor(s), mobile phones, computers, intelligent scales, etc., to promote behavior change based on mindfulness.

Aspects of mindfulness methodologies may comprise, for example, schemas related to matching donations, competitive pursuits, avatar-based approaches, family-centric games, tracking and alleviating stress, anger, sadness, and lethargy/not feeling up to a task, and the like. In one aspect, ingestible device-enabled pills (active or placebo) associated with the mindfulness methodology may be custom labeled or pre-labeled by the distributor (e.g., pharmacist, doctor, drug store) with an “antidote” for tracking and also alleviating negative emotions. In one aspect, the labels comprise the text “Focus” for stress, “Calm” for anger, “Happy” for sadness, and “Willpower” for lethargy/not feeling up to a task. One aspect of the ingestible device-enabled pills is discussed hereinbelow.

In addition, the mindfulness methodology according to the present disclosure may enhance a high level of mindfulness toward an individual's emotions to provide a “pre-emptive power up” to tackle daunting tasks or stressors early on. In doing so, the individual can avoid getting to the “high stress” or “despair” level.

Versatile aspects of the mindfulness methodology provide for linkage of and/or utilization of existing automated systems. Existing systems may include, for example, computerized systems, social networks and media, health management networks, etc.

Generally, an individual journey may follow three primary stages of (1) getting started with a therapy regimen for treatment of chronic disease(s); (2) getting into a routine to establish good habits and choices to follow and adhere to the therapy regimen and other positive lifestyle choices, e.g., diet, sleep, exercise, etc.; and (3) getting through rough spots and difficult periods in therapy and disease progression or difficulties to continue to make progress in chronic disease management and continued wellbeing. Aspects of the present disclosure may create product mechanisms for sustained behavior change and continuous reinforcement in each of these stages of the individual journey through the novel use of creative, automated methodologies.

One such methodology facilitates mindfulness promotion and behavior change based on the mindfulness methodology described herein. Under the mindfulness methodology, personal act(s) of mindfulness promotion, e.g., an act of ingestion of a product such as medication or a placebo, are linked to matching altruistic goal(s). The actual confirmation of the personal act, e.g., ingestion event, is a precursor to making such a system work, as opposed to using a surrogate of the act, such as individual memory, individual reporting, smart packaging or bottles, etc.

Using the mindfulness methodology, in various aspects product mechanisms may be created for sustained behavior change and continuous reinforcement in the following manner.

In one aspect, a “Get Me Started” mindfulness methodology activates an individual's desire to become more aware and mindful in all activities and movements both physical and mental simply by taking the pill(s) already prescribed by their physician, whether real or placebo, regardless of whether the individual was informed that the pills were placebos, and regardless of whether the individual was advised to believe in the placebo effect.

In one aspect, a “Get Me into a Routine” mindfulness methodology gives an individual short-term reinforcement, connecting the daily and sometimes mundane task of taking a pill to a more inspirational motivation of helping another human being. The mindfulness methodology also can connect an individual with others like them, showing how the collective pill ingestions of other individuals in the mindfulness methodology program are supporting a cause such as ending tuberculosis in India or providing medications to underprivileged children in a neighboring city.

In one aspect, a “Get Me through the Rough Spots” mindfulness methodology provides a higher purpose and motivation to keep going and get back on track, and to not break from the positive routine when an individual has had setbacks in their treatment, side effects from medications, or is feeling down and frustrated about their condition.

In one aspect, the mindfulness methodology, an important social effect (support for an individual or cause in need) and economic consequence (another product of real financial value being donated) is created by a personal consumer decision, and therefore the “donation transaction” must be verified and quantifiable. Direct measurement of the actual act, e.g., actual ingestion, is part of the product concept. Direct measurement may be accomplished via a variety of devices, as hereinafter discussed.

To illustrate, any individual or group ingests a medication having an integrated, ingestible device that marks an ingestion event. (Examples of such devices are described, for example, in U.S. Pat. No. 7,978,064 issued Jul. 12, 2011 entitled “COMMUNICATION SYSTEM WITH PARTIAL POWER SOURCE, infra.) The integrated device communicates relevant mindfulness methodology data, e.g., mindfulness promotion data, identification of an individual, type of medication, time of ingestion, and dosage information, to a computer or mobile device having a processor and specific software. The software/processor processes the mindfulness promotion data and, upon identification of a predetermined behavior change methodology, the software/processor generates a corresponding instruction to initiate software associated with the identified behavior change methodology.

In one example, the mindfulness promotion data identify the individual who has ingested the medication. The software/processor checks a database or other storage media to determine if the identified individual has a corresponding behavior change methodology program in place. Upon determining that such a program is in place, e.g., the individual has selected the mindfulness methodology the software/processor generates an instruction, e.g., initiates a software program, which facilitates an individual's awareness and mindfulness in all activities and movements both physical and mental.

One example may be a provision of awareness and mindfulness of “matching” a dose of medication to an individual in need. Thus, upon ingestion of a product by an individual, a “one for one” or “one for many” donation of a second designated product (or multiple products) to another individual, group or cause occurs.

For example, an HIV+ individual living in Boston, Mass., USA may set up the mindfulness methodology to donate HIV medication to another HIV+ individual living in Nairobi, Kenya every time the Boston individual took his own medication as prescribed. Rather than taking the medication because they are “told to” by their physician or because of a personal sense of longer-term health reward or disease progression fear (mental models which the scientific literature on adherence confirms have failed to support sustained adherence and persistence to drug therapy in the majority of individuals living with chronic disease), the mindfulness methodology supports and reinforces the act of the Boston individual taking a daily pill by creating a short-term, inspirational goal of helping another individual in need.

The mindfulness methodology replaces a difficult to conceive abstraction (if I take this pill every day for the next 10 years I may live longer) with a certainty (if I take this pill today I may help someone else today). Over time, this positive daily reinforcement may be complemented by a negative reinforcement as well, in that any personal failure to take the medication as prescribed may result in the removal of the support the Boston individual has been giving to the Nairobi individual. This negative reinforcement further reinforces and sustains the Boston individual's product usage and adherence.

The mindfulness methodology may further allow product manufacturers to associate the persistent and increased usage of their products by consumers with positive social causes that the manufacturers already pursue as part of corporate responsibility, charitable giving, and global health programs. For example, the pharmaceutical company that manufactures the HIV medication for the Boston individual may link the mindfulness methodology to its global AIDS program and its work with the Gates Foundation, Clinton Global Initiative, WHO and other government-sponsored program to make its expensive HIV medications available to individuals in underserved places, and link the medication supplies it already commits for such programs to the ingestion events of individuals like its Boston consumer. This creates a reinforcing, virtuous circle, where the Boston consumer increases and sustains her adherence to the pharmaceutical company's HIV medication, the pharmaceutical company attains further recognition for its global HIV medication access program and credit for it in its primary markets, and the consumer and pharmaceutical company create a new, positive relationship with each other based on the new HIV pill brand, a relationship that may be durable beyond such things as the expiration of a patent on the HIV pill itself.

Further, the nature of the consumer/pharmaceutical company relationship based on the mindfulness methodology is unique and valuable—the individual may now perceive herself to be directing and controlling the pharmaceutical company, versus a current perception born of direct-to-consumer (DTC) advertising where the consumer may feel manipulated, overcharged, and controlled by the pharmaceutical company.

Additionally, the mindfulness methodology may allow companies to have a global health strategy far in advance of when they are capable of having a truly global health infrastructure to support this strategy. Small companies such as assignee Proteus Biomedical, Inc., Redwood City, Calif., USA, may have a viable presence and contribute to global health needs in countries like Kenya, China, and India even before such companies are able to have commercial operations in those locations.

Still further, the mindfulness methodology may facilitate feeding donations back into the donor's own community, such as church groups or professional organizations, e.g., truck drivers helping each other.

The mindfulness methodology may further allow consumers and product manufacturers to create online social communities based on the linkage between personal ingestion decisions and medication donations and social causes. Organizing individual participants and recipients into groups may boost motivation because organization increases the perceived impact of an individual's actions. For example, a website may show both the Boston individual's personal impact and the cumulative good a community of other HIV+ individuals in the mindfulness methodology program has done. Such a social community may have a further reinforcing effect on the individuals like the Boston individual. Through this group dynamic, support and performance becomes another driver for behavior change to adherence, and the cumulative effect that a large community can have on a cause becomes inspirational over and above what any individual can do themselves.

The mindfulness methodology needs not associate an individual with a single cause related to their own medical condition, or even with health-related causes at all: product manufactures or consumers themselves may create multiple causes and social issues that an individual can select to match to their personal ingestions. A skilled artisan may note that the number of causes and the uses of the mindfulness methodology to enable those causes may be many and varied to create awareness, meaning, and motivation for the individuals and their online social groups, such as (a) if the individual meets their step-counting goals a pair of shoes is donated to someone in need or a donation is made toward helping those who lost limbs due to landmines; (b) if an individual meets their sleep duration goals a donation is made to a housing project that may provide someone in need a safe place to sleep; (c) if a diabetic individual meets their nutritional or weight loss goals food may be donated to people in need (“every pound lost is a pound of food donated”); and (d) other such linkages.

In one aspect, the mindfulness methodology may further extend the online social community to link an individual or group to other individuals or groups. In this aspect, motivation for the individual is created by the ability of the individual and the recipient to share stories and observations about their respective awareness of diseases, situations and lives. This social connection may be static, e.g., the Boston individual is able to read a biography and life story about the Nairobi individual, as well dynamic and interactive, e.g., the Boston and Nairobi individuals have a dialogue with updates via various social media and networks such as Twitter, Facebook, SMS or MMS messaging, email, etc.

The mindfulness methodology may further allow consumers who are individuals but are not on a device-enabled medication, or are not even individuals at all, to participate. In various aspects, the system and/or method may include a device-enabled placebo or vitamin tablet that can be ingested by any individual under various circumstances: (1) ingested by itself; (2) co-ingested with medications that are not device-enabled to mark ingestion by an individual; (3) ingested at any time by an individual or any other consumer, etc.

For example, the Boston individual's physician switches him to a different HIV medication because of side effects and viral resistance issues, and that medication is not device-enabled to mark ingestion. The Boston individual feels a strong connection to the mindfulness methodology program, and has come to be aware of personal benefits his adherence is creating. He is pleased when his pharmacist tells him that there is even a mindfulness methodology tablet without a medication, e.g., a device-enabled placebo, which enables him to continue his participation in the mindfulness methodology program. The pharmaceutical company that manufactured his old medication is also pleased because they are able to continue their relationship with the Boston individual while they develop or acquire other device-enabled medications for their portfolio that may be suitable for him over time.

Another example is a non-individual consumer or advocacy group interested in using the mindfulness methodology for a fundraising or support event. A group raising money for a cancer institute, for example, may link its annual cycling ride charity fundraiser to the mindfulness methodology, where participants all train in the months leading up to the ride while using the system, and finish use once the race is completed. In this example, the fundraising ride of 2,000 individuals may have daily training activity and placebo ingestions all linked to the matching donor giving that raises money for the charity. In a third example, a family care giver shows her support for a loved one living with a chronic illness by being aware or mindful of their drug adherence by taking a device-enabled placebo at the same times during the day that the loved one needs to take their medications. This aspect creates family support and also links family efforts to the mindfulness methodology cause that they have selected, so that the family group can see their cumulative support for their cause.

Further, product manufacturers may be able to enter into a greater number of more favorable arrangements with payors by including an altruistic element to their product marketing programs. The altruism may be applied to other members of the payor population, e.g., if a member ingests per prescribing guidelines, another member may get help with co-pays or the payor itself gets a discount.

In various aspects, the mindfulness methodology have design provisions that protect against and/or take predetermined protective action(s) upon the occurrence of various events, e.g., overuse by an individual; a possible situation where someone may try to do “more good” by taking more than a prescribed amount of their medication; or sudden stoppage of medication usage by the donor, etc.

In one example, the mindfulness methodology may enhance awareness and mindfulness only when the individual takes a prescribed dose, no more and no less. In various aspects, this check may be performed in an automated fashion by software/processor by comparing stored data indicating the dosage amount and frequency of a prescribed medication against mindfulness promotion data communicated by a device associated with the prescribed medication, e.g., a device-enabled pill, syringe, inhaler, etc. that communicates dose, time of dose, type of dose at each delivery event. In another example, an independent third party may manage the mindfulness methodology program on behalf of a product manufacturer. In still another example, the system/method automatically monitors stoppage events and ensure predetermined actions are taken, e.g., the medication supply continues uninterrupted on behalf of the pharmaceutical company.

### System Environment

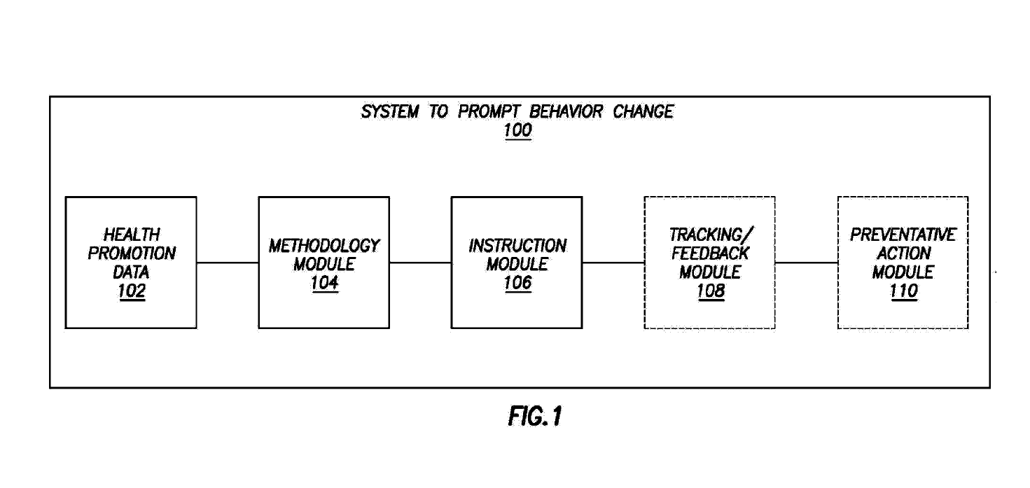

Prior to describing various aspects of a mindfulness methodology, the present disclosure now turns to the description of a system in which the mindfulness methodology may be practiced. Referring now to FIG. 1, there is shown a schematic of a system to prompt behavior change 100, including mindfulness methodology data or health promotion data 102 generated and/or communicated from/to a device; a methodology module 104 associated with software/processor to identify at least one behavior change methodology associated with the mindfulness methodology data 102; and an instruction module 106 associated with a software/processor to initiate the identified at least one behavior change methodology. Optionally, and in various aspects, a tracking/feedback module 108 may track and/or provide feedback associated with the mindfulness methodology data 102, the behavior change methodology, the initiation of the behavior change methodology, etc. Optionally, and in various aspects, a preventative action module 110 may initiate a preventative, corrective, or other action.

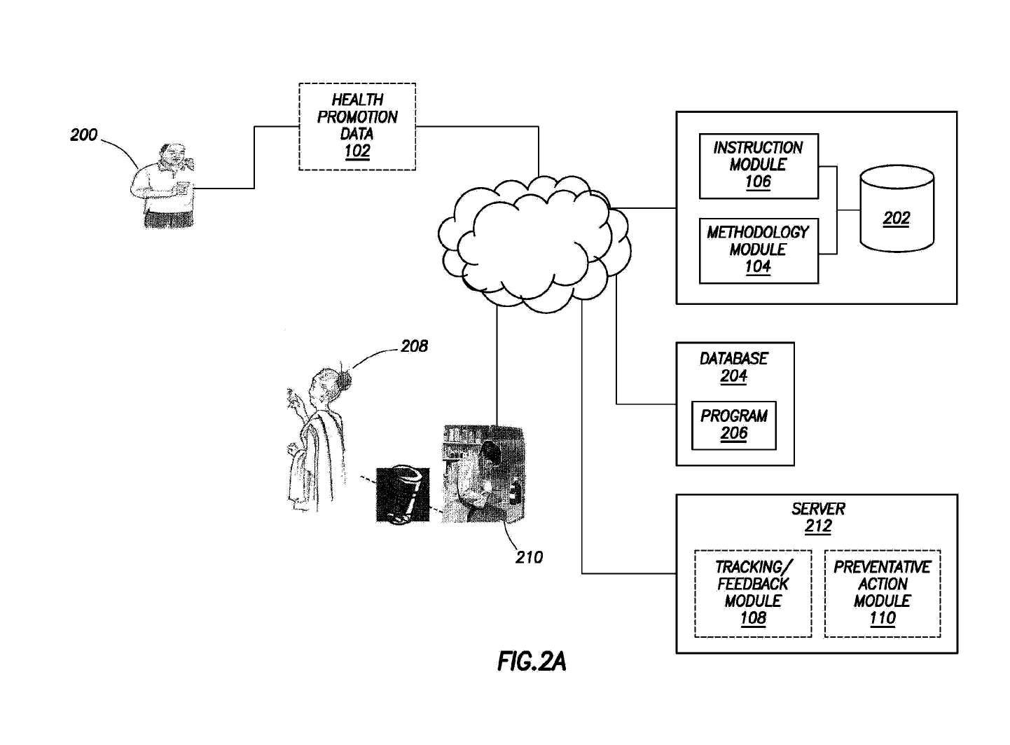

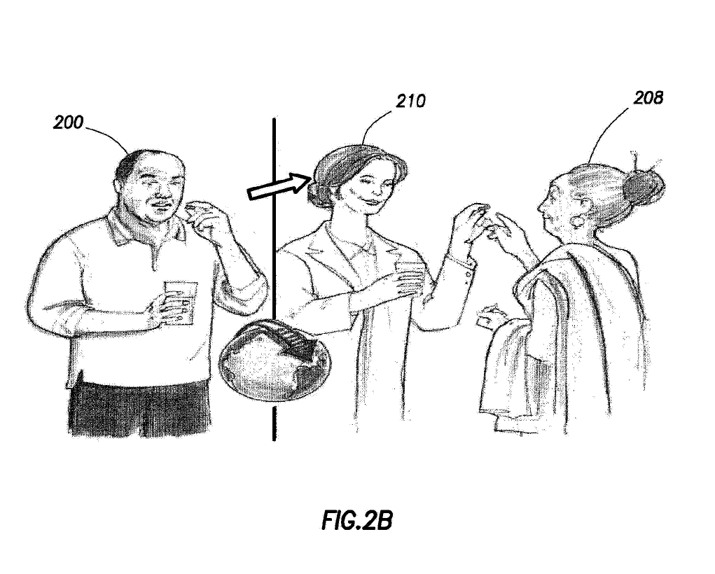

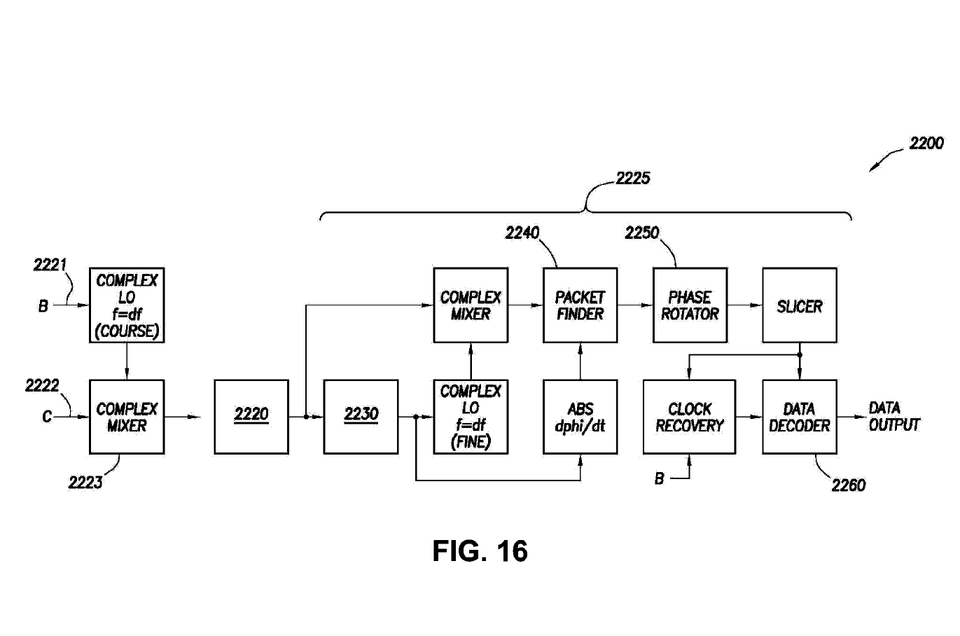

For example, and with reference to FIGS. 2A and 2B, where there are shown a system operation of the system to prompt behavior change 100 of FIG. 1 and one conceptualization of a mindfulness methodology, respectively. With continuing reference to the foregoing mindfulness methodology illustration, an individual 200 ingests a device-enabled medication (not shown), whether active or placebo, which communicates mindfulness methodology data 102 such as the time of ingestion and individual identification information to the individual's detector device (FIGS. 16-21). The detector device, for example, may be implemented as an on-body, adhesive communication patch (not shown). In this example, the detector device also collects mindfulness promotion data such as physiologic data, e.g., heart rate, heart variability, angle of repose, etc.

The detector device forwards the combined mindfulness methodology data 102 to the individual's mobile phone for onward communication to a hub, shown herein as first server 202, which includes the methodology module 104, instruction module 106, and a database 204.

Various aspects include the server 202, or other such hub device. As used herein, the term hub includes any hardware device, software, and/or communications component(s), as well as systems, subsystems, and combinations of the same which generally function to communicate the mindfulness methodology data 102. Communication of the mindfulness methodology data 102 includes receiving, storing, manipulating, displaying, processing, and/or transmitting the mindfulness methodology data 102. In various aspects, the hub also functions to communicate, e.g., receive and transmit, non-mindfulness methodology data. Broad categories of hubs include, for example, base stations, personal communication devices, and mobile telephones. Examples of a hub and other devices are discussed in U.S. Patent Application Publication No. 2011-0009715 A1 published Jan. 13, 2011 entitled “INGESTIBLE EVENT MARKER DATA FRAMEWORK,” infra.

The methodology module 104 processes the mindfulness methodology data 102 which include an identifier for the Boston individual 200. Of note, the mindfulness methodology data 102, the methodology module 104, and/or other system components may use personal identifiers such as name, etc., anonymous identifiers such as assigned numbers, or other identifiers to determine whether the mindfulness promotion or methodology data 102 are associated with one or more methodologies. The methodology module 104 uses the identifier to compare with stored information in the database 204 to determine if the individual 200 is a participant in one or more methodologies. In this example, the methodology module 104 processes the mindfulness methodology data 102 and identifies the data as associated with the individual 200 and as a participant who has selected the mindfulness methodology program.

The instruction module 106 initiates, on a data system, shown herein as the database 204 run by a second server, a program 206 to facilitate donation of a medication to the Nairobi individual 208. The program 206 may be, for example, one or more software applications which provide one or more functions necessary to administer a methodology, e.g., a donation. For example, a mindfulness methodology software application may interact with one or more networks of systems, systems, system components, and/or devices to provide information regarding updates on donations to recipients, e.g., identity of recipient, type of medication, date and method of delivery to recipient, pharmacy 210 providing medication, dosing instructions for recipient, manufacturers/donors responsible for the donations, etc.

In various aspects, one or more hubs store, manipulate, and/or forward, directly or indirectly, the mindfulness methodology data 102, alone or in combination with other data, to one or more data systems. The data systems include any hardware device, software, and/or communications component, as well as systems and subsystems of the same, which generally function to provide a service or activity related to the mindfulness methodology data 102, e.g., program 206, which provides instructions for the mindfulness methodology software application.

The example further includes a third server 212 having the tracking/feedback module 108 and the preventative action module 110. Acting independently of or interoperatively with one another, the tracking/feedback module 108 and preventative action module 110 receive data from any one or more variety of sources, e.g., the individual's mobile phone, the methodology module 104, the instruction module 106, the program 206, the pharmacy system 210, and/or other sources.

The tracking/feedback module 108 receives, collects, etc., data regarding individual donors, groups of donors, causes donated to, etc., and provides feedback relevant to one or more methodologies to networks, computers, devices, etc., associated with various interested parties, e.g., the donor, the manufacturer, and the recipient.

The preventative action module 110 receives, monitors, processes, etc., data regarding boundary conditions, events, etc. relevant to use of the system. One such category of data is the monitoring for proper ingestion of medication to avoid over-ingestion, under-ingestion, improper dosage times, etc. For example, the mindfulness methodology data 102 may include information regarding the type and dosage frequency of a particular medication. The preventative action module 110 may compare such data against data stored in the database 204 having dosage instructions for the individual 200 and for the Nairobi individual 208. Upon identification of a discrepancy, the preventative action module 110 may generate appropriate alerts, communications, etc., to the individual 200, to the health care provider(s), to the pharmacy 210, etc. to ensure dosing is brought back into conformance with or remains within prescribed regimens.

The mindfulness methodology data 102 may include any and all data related to promoting, maintaining, establishing, improving, etc., the awareness and mindfulness in all activities and movements both physical and mental health of an individual. The mindfulness methodology data 102 explicitly includes data that are machine-compatible, e.g., capable of being generated by, read by, written to, stored on or within, communicated from or to, and/or processed by a tangible machine or machine component, e.g., automatable data. Examples of machines and machine components include networks of computers, computers, storage media, communication devices, processing devices, circuitry, etc., as may be now known or provided in the future. Examples of data content include individual identification; type, manufacturer, amount, time, and mode of delivery of products, e.g., medications, placebos, vitamins, foodstuff, etc. Examples of mode of delivery include ingestion, injection, inhalation, infusion, transdermal, and insertion. Examples of devices that generate the mindfulness promotion data 102 include ingestible devices; intelligent syringes; intelligent IV bags; intelligent inhalers; intelligent infusers and catheters; data receivers and detectors, e.g., personal health companions, smart packaging, memory and reminder tools; blood pressure cuffs; scales, glucometers, exercise tools and devices, eating habit trackers, medical and hospital devices, and other health-promoting devices. Examples of smart syringes and injection events, for example, include those discussed in U.S. Pat. No. 8,114,021 issued Feb. 14, 2012 entitled “BODY-ASSOCIATED RECEIVER AND METHOD,” infra. Examples of intelligent inhalers and inhalation events include those discuss in U.S. Provisional Patent Application No. 61/373,803 filed Aug. 13, 2010 entitled “SYSTEM AND METHOD FOR DELIVERY AND DETECTION OF AN INHALABLE DOSE”, infra. As used herein, the term “health-promoting devices” means any device, component, etc., capable of precise measurement of one or more health related parameters, e.g., heart rate, heart rate variability, angle of repose, accelerometer data, ingestion event, injection event, inhalation event, infusion event, drug depot release event, etc. This is in contrast to more subjectively-derived data such as individual-entered estimates of measurements, events as recorded by individuals, etc.

Various aspects extend to non-medication and medication-like medical devices and monitoring products, where the adherence to a medical, awareness and mindfulness-related regimen can link a personal decision or choice to an altruistic goal and associated donation, show of support etc. For example, the wearing and/or use of a hearing aid, a pedometer, a weight scale, a blood pressure cuff, a blood glucose meter, etc., may all enable the mindfulness methodology: any sensor-enabled measurement of personal decisions, choices and physiologic state, such as sensed parameters of heart rate, sleep, activity, respiration, diet and molecular parameters such as blood glucose, cholesterol, creatinine, etc., may be linked to the mindfulness methodology. Another example is any assessment of food consumption and caloric intake enabling the mindfulness methodology, where a target goal (such as lower caloric intake) drives the mindfulness methodology process. Another example is smoking cessation, where devices that demonstrate a decline in cigarettes or related products being consumed enable the mindfulness methodology to make donations for every product not consumed by the individual.

Examples of the foregoing devices include, but are not limited to, those described in: U.S. Patent Application Publication No. 2008-0284599 A1 published Nov. 20, 2008 entitled “PHARMA-INFORMATICS SYSTEM,” U.S. Patent Application Publication No. 2009-0227204 A1 published Sep. 10, 2009 entitled, “PHARMA-INFORMATICS SYSTEM,” U.S. Patent Application Publication No. 2011-0009715 A1 published Jan. 13, 2011 entitled “INGESTIBLE EVENT MARKER DATA FRAMEWORK,” U.S. Patent Application Publication No. 2012-0011699 A1 published Jan. 19, 2012 entitled “HIGH-THROUGHPUT PRODUCTION OF INGESTIBLE EVENT MARKERS,” PCT Patent Application No. PCT/US10/34186 filed on May 10, 2010, published as WO 2010/132331 on Nov. 18, 2010, entitled “INGESTIBLE EVENT MARKERS COMPRISING AN IDENTIFIER AND AN INGESTIBLE COMPONENT,” U.S. Patent Application Publication No. 2009-0082645 A1 entitled, “IN-BODY DEVICE WITH VIRTUAL DIPOLE SIGNAL AMPLIFICATION” published Mar. 26, 2009, U.S. Patent Application Publication No. 2011-0054265 A1 published Mar. 3, 2011 entitled “HIGHLY RELIABLE INGESTIBLE EVENT MARKERS AND METHODS OF USING SAME,” U.S. Patent Application Publication No. 2009-0082645 A1 published Mar. 26, 2009 entitled “IN-BODY DEVICE WITH VIRTUAL DIPOLE SIGNAL AMPLIFICATION,” U.S. Pat. No. 7,978,064 issued Jul. 12, 2011 entitled “COMMUNICATION SYSTEM WITH PARTIAL POWER SOURCE,” U.S. Pat. No. 8,114,021 issued Feb. 14, 2012 entitled “BODY-ASSOCIATED RECEIVER AND METHOD,” PCT application serial no. PCT/US2007/082563, published as WO 2008/052136 on Mary 2, 2008, entitled “CONTROLLED ACTIVATION INGESTIBLE IDENTIFIER,” PCT application serial No. PCT/US2007/024225 published as WO 2008/063626 on May 29, 2008 entitled “ACTIVE SIGNAL PROCESSING PERSONAL HEALTH SIGNAL RECEIVERS,” PCT application serial no. PCT/US2007/022257 published as WO 2008/066617 on Jun. 5, 2008 entitled “LOW VOLTAGE OSCILLATOR FOR MEDICAL DEVICES,” PCT application serial no. PCT/US2008/052845 published as WO 2008/095183 on Aug. 7, 2008 entitled “INGESTIBLE EVENT MARKER SYSTEMS,” PCT application serial no. PCT/US2008/053999 published as WO 2008/101107 on Aug. 21, 2008 entitled “IN-BODY POWER SOURCE HAVING HIGH SURFACE AREA ELECTRODE,” PCT application serial no. PCT/US2008/056296 published as WO 2008/112577 on Sep. 18, 2008 entitled “IN-BODY POWER SOURCE HAVING MULTI-DIRECTIONAL TRANSMITTER,” PCT application serial no. PCT/US2008/056299 published as WO 2008/112578 on Sep. 18, 2008 entitled “IN-BODY POWER SOURCE HAVING DEPOLYABLE ANTENNA,” PCT application serial no. PCT/US2008/077753 published as WO 2009/042812 on Apr. 2, 2009; U.S. Patent Application Publication No. US 2008-0284599 A1 published Nov. 20, 2008 entitled “PHARMA-INFORMATICS SYSTEM,” U.S. Patent Application Publication No. 2011-0009715 A1 published Jan. 13, 2011 entitled “INGESTIBLE EVENT MARKER DATA FRAMEWORK,” U.S. Patent Application Publication No. 2009-0118594 A1 published May 7, 2009 entitled “SMART PARENTERAL ADMINISTRATION SYSTEM,” U.S. Pat. No. 8,121,000 issued Feb. 21, 2012 entitled “ACOUSTIC PHARMA-INFORMATICS SYSTEM,” and U.S. Provisional Patent Application No. 61/373,803 filed Aug. 13, 2010 entitled “SYSTEM AND METHOD FOR DELIVERY AND DETECTION OF AN INHALABLE DOSE.”, and U.S. Provisional Patent Application No. 61/431,416 filed Jan. 10, 2011 entitled “SYSTEM, METHOD AND ARTICLE TO PROMPT BEHAVIOR CHANGE,” each of the foregoing is incorporated by reference in its entirety.

The methodology module and the instruction module include any implementation of software, hardware, firmware or combinations of the foregoing, whether standalone, integrated with other modules or multiple devices, etc., so long as the modules are capable of carrying out the functions described herein. Either or both of the modules may be associated with, e.g., may be resident on, executable by, displayable by, etc., a component, a device, a computer, a network or networks of communicating devices, etc.

### Mindfulness Methodology

The mindfulness methodology according to the present disclosure provides a combination of powerful technologies that provides rich feedback as well emotional rewards from the act of ingestion. The act of ingestion provides the individual with a strong belief that they can control their moods and monitor them more diligently. This is a useful aspect of the mindfulness methodology because it makes it simple for the individual to provide data to the system from their mobile phones for the purpose of mood tracking. The mindfulness methodology also provides meaningful, instant feedback to the individual. These and other aspects are discussed hereinbelow.

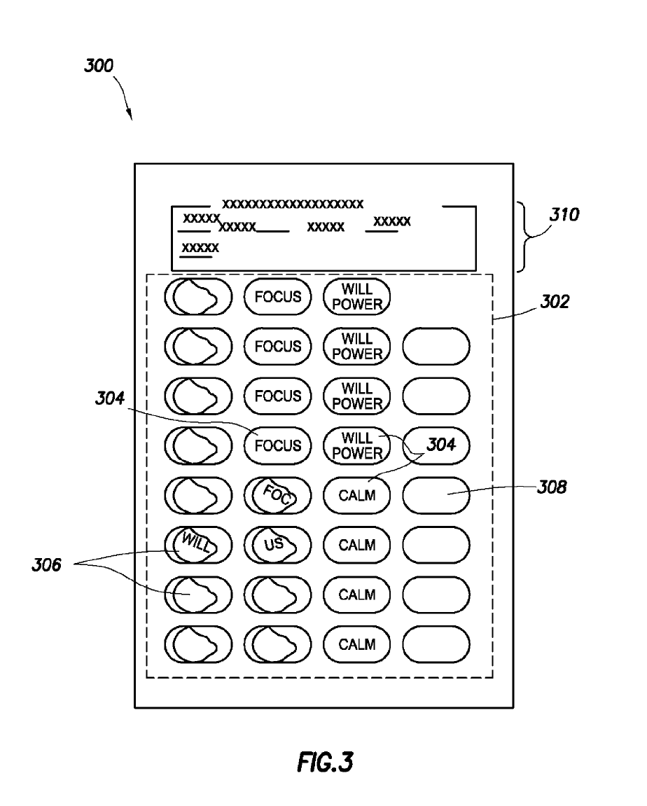

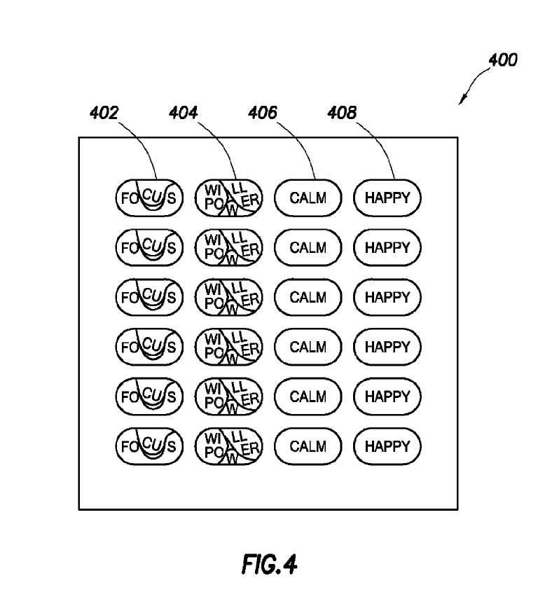

In one aspect, the mindfulness methodology may be described in conjunction with a mindfulness ingestible device dispensing apparatus 300, 400 as illustrated in FIGS. 3 and 4, respectively. With reference to FIG. 3, as previously described, according to the placebo effect, the IBS study found that placebos also work when labeled as placebos (placebos without deception). Accordingly, in one aspect of the mindfulness methodology, mindfulness promotion devices referred to herein as mindfulness ingestible devices, which may include placebos, may be packaged in the dispensing apparatus 300. The dispensing apparatus 300 comprises a plurality of compartments 302 that contain an ingestible device. As shown in FIG. 3, in one aspect, the ingestible devices are contained within 31 individual blister pack compartments for a month's supply of emotional mindfulness ingestible devices. In other aspects, other customized packages are included for example, bi-weekly, weekly supplies, etc. Labeled blister pack compartments 304 may be labeled (e.g., willpower, focus, calm, happy, among others, etc.). Opened blister compartments 306 show where the mindfulness ingestible device dispensing apparatus 300 had been stored prior to use. A header portion 310 is provided to identify information associated with the individual.

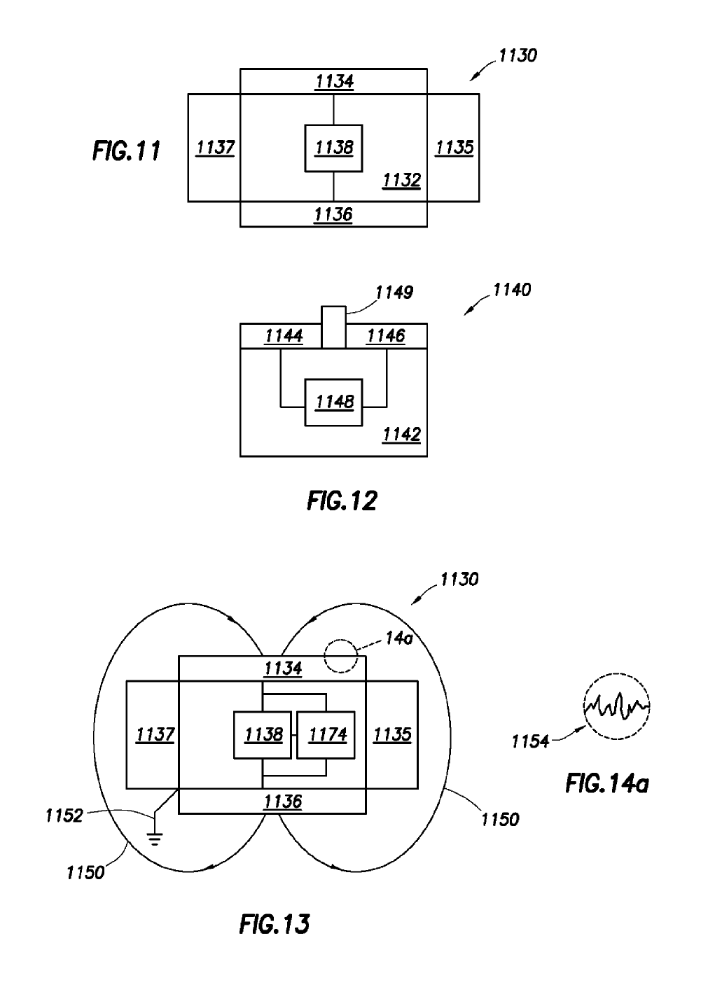

In one aspect, the ingestible device may comprise an event marker, such as an ingestible event marker (IEM) that is configured to communicate with an external receiver/detector, such as a wearable electronic patch, to record the type of ingestible device ingested by the individual and a time and date stamp of ingestion. Various enabling aspects of the IEM are illustrated in FIGS. 11-15 below, and various enabling aspects of the receiver/detector are illustrated in FIGS. 16-21 below. In one aspect, a placebo may be configured as an ingestible device comprising an event marker, such as, for example, an IEM and may be referred to herein as an IEM-enabled placebo pill, for example. In one aspect, the IEM-enabled placebo pill may be marked either by the distributor or by the individual consumer, e.g., the patient or user. For example, the individual may receive the dispensing apparatus 300 pre-filled or pre-packaged with IEM-enabled placebo pills located within the individual blister compartments 302. The individual blister compartments 302 may be unlabeled when obtained by the individual. Accordingly, the individual may assign labels to the unlabeled blister compartments 308 of the dispensing apparatus 300 to identify the purpose for the IEM-enabled placebo pills.

In one aspect, the IEM-enabled placebo pills may be labeled with an “antidote” to negative emotions that the individual wishes to track and/or alleviate. With reference now to FIG. 4, in one aspect, a mindfulness ingestible device dispensing apparatus 400 may comprise multiple labeled individual blister compartments. Compartments labeled “Focus” contain stress type IEM-enabled placebo pills 402 (focus pills 402). Compartments labeled “Willpower” contain lethargy/not feeling up to a task type IEM-enabled placebo pills (energy pills 404). Compartments labeled “Calm” contain anger type IEM-enabled placebo pills (calmness pills 406). Compartments labeled “Happy” contain sadness type IEM-enabled placebo pills (happiness pills 408).

One aspect of the mindfulness methodology according to the present disclosure is the employment of the placebo effect. It is known that for many diseases, taking a sugar pill that the individual believes or thinks may help them, does indeed alleviate the individual's symptoms. It is also known that wearing a medical device, even if it is turned off, may help the individual's health. Furthermore, as previously discussed, an IBS study found that when individuals were given a placebo and told that it was a placebo and not real medication, the placebo was still effective in relieving symptoms. Accordingly, there is some psychological association with the medical ritual of pill ingestion.

With this in mind, an experiment was conducted where people who were dieting received packs of small white sweet sugar-like candy known under the trade designation of Tic-Tacs and were labeled “willpower.” Each of the individuals participating in the experiment took an amount of Tic-Tacs each morning, corresponding to how much willpower each person thought they would need to get through the day. The result was that people experienced “enhanced willpower,” extending beyond just dieting. To extend the experiment, four negative emotions, for example, were targeted for both tracking and combating. The mindfulness methodology was employed in the experiment to make the individual aware or mindful and also track negative emotions. Additionally, the ingestion ritual provides the individual with the feeling of an emotional “power up” to combat the identified negative emotional feelings.

In one aspect, the placebo sugar-like candy can be replaced or supplemented with an ingestible technology, e.g., a technology enabled by Proteus Biomedical, Inc, Redwood City, Calif., USA, where the ingestible device is configured to communicate with a mobile device (e.g., mobile phone, smart phone, tablet computer, laptop, personal digital assistant, among other mobile devices) either directly or through a receiver/detector, such as a wearable electronic patch. In one aspect, the ingestible device may comprise an IEM-enabled ingestible device that enables the individual to communicate with their mobile device and signal when they have been ingested, turning the IEM-enabled ingestible device in conjunction with the mobile device into a mood tracking system. In addition, the IEM-enabled ingestible device may also be employed for tracking the individual's heart rate, activity levels, and sleep length and quality for the duration of the experiment via the receiver/detector that is worn throughout the experiment.

Although one aspect of the mindfulness methodology technology is to assist individuals to manage their health more effectively, in another aspect, the technology may be employed in a different manner in a mood tracking system. In one aspect, the IEM-enabled ingestible device may be employed as an “antidote” to negative emotions. Accordingly, upon ingestion, the IEM-enabled ingestible device pill is configured to communicate its identification (“ID”) information to a mobile device, either directly or through the receiver/detector patch, and communicate to the system to prompt behavior change 100 which the individual had just taken a pill for. Thus, the individual's mobile phone, in combination with the IEM-enabled ingestible device pill and/or the receiver/detector patch, can be used to implement a mood tracking system. As described in more detail below, a week-long experiment was conducted using the “emotion” pills (e.g., the mindfulness ingestible device pill 402, 404, 406, 408). In addition, the IEM-enabled ingestible device pill, mobile device, and/or receiver/detector patch system can be configured provide consolidated data on activity, sleep, and medication timings.

Accordingly, in use, the individual can employ the mindfulness ingestible device dispensing apparatus 400 in conjunction with the system to prompt behavior change 100 (FIG. 1) to monitor their emotions and takes a corresponding antidote mindfulness ingestible device pill 402, 404, 406, 408 when the individual feels a negative emotion. During use, the system to prompt behavior change 100 is configured to monitor the individual's biometric data, as well as time-stamping ingestion of each of the mindfulness ingestible device pills 402, 404, 406, 408.

In an experiment, an individual was instructed to take an antidote mindfulness ingestible device pill 402, 404, 406, 408 when the individual feels a negative emotion while to commuting to work on a bicycle. The antidote mindfulness ingestible device pills were non-pharmaceutical placebo “smart pills” (e.g., IEM-enabled ingestible placebo devices) labeled as focus pills 402, energy pills 404, calmness pills 406, and happiness pills 408. The individual was instructed to take one of the pills 402, 404, 406, 408 when the individual felt a negative emotion creeping up that the individual wanted to control or combat during the bike commute. The focus pill 402, willpower pill 404, calmness pill 406, and happiness pill 408 IEM-enabled ingestible devices were configured to communicate after ingestion with the individual's mobile device either directly or through an electronic receiver/detector (e.g., a wearable electronic patch).

In addition, it was observed that during the bike commute the individual experienced peculiar pill-related thoughts that may have driven the individual's actions, such as “I should bike faster to take advantage of my energy power up!” Also, after taking the willpower pill 404 mindfulness ingestible device, the individual may feel like they may have a window of time (e.g., 10 minutes) to “indulge” in negative emotions before the willpower pill 404 mindfulness ingestible device hits their bloodstream and the individual started to use its power to help the individual control the negative emotion. In addition, a high level of mindfulness toward the individual's emotions may provide the individual with a “pre-emptive power up” to tackle daunting tasks or stressors early on. In doing so, the individual may avoid getting to “high stress” or “despair” levels of negative emotions. Throughout the bike commuting example, the individual did not use the calmness pill 406 or happiness pill 408 mindfulness ingestible devices. During the bike commuting example, the individual used only the focus pills 402 and the willpower pills 404 mindfulness ingestible devices. This is especially interesting as it ties in closely with the effects of Buddhist mindfulness meditation.

FIG. 5 illustrates a graphical representation of the results of a mindfulness experiment. The results of a bike commuting mindfulness experiment shown in FIG. 5 include a top graph 502 showing the days during which the bike communicating experiment was conducted along the horizontal axis (e.g., 7/9, 7/10, 7/11, 7/12, 7/13, etc.). The number of steps, sleep start, sleep stop, and median heart rate provided by the system to prompt behavior change 100 (FIG. 1) are shown along the vertical axis of the top graph 502. These values are recorded by the tracking/feedback module 108 (FIG. 1). The bottom graph 504 shows when the individual took the willpower mindfulness ingestible device pill 404. The events are marked along the horizontal axis corresponding to the day and time-stamp applied to each ingestion of a mindfulness ingestible device pill. As shown in the bottom graph, during the period shown along the horizontal axis, the individual ingested the focus pill 402 mindfulness ingestible device at events marked with reference number 512 and the willpower pill 404 mindfulness ingestible device at events marked with reference number 514 time are shown on the bottom graph 504.

From the raw experimental data shown in FIG. 5, it can be determined that, when bike commuting, the individual had on average a higher heart rate for the bike rides when the individual took the energy pill 402 or willpower pill 404 before. As indicated by the top graph 502, the biggest heart rate spikes occurred after the individual ingested the energy pills 402. For example, in the bike commuting experiment, the mindfulness methodology was employed such that during the bike commute, the individual had on average a higher heart rate for the bike rides whenever the individual took the willpower pill 402 or the energy pill 404 before initiating the bike commute. In fact, the data shows that the biggest heart rate spikes occurred after ingesting the energy pills 404.

In accordance with the results of the bike commuting experiment, the individual was primarily focused on using the focus pills 402 and the willpower pills 404 rather than the calmness pills 406 or happiness pills 408, which kept the individual constantly engaged, pushed the individual to reach all of their goals for the day, and enabled the individual to follow through with their plans. This concept may be extended to other activities, such as, for example, not skipping workouts, going on bike rides, doing chores. Because of this focus, the other negative emotions that the individual was hoping to avoid, such as, for example, sadness, stress, and/or anger were washed out. The individual would be mindful of their feelings about the tasks they were facing and give themselves a “pre-emptive power up” to tackle daunting tasks or stressors early on. In doing so, the individual avoided getting to the “high stress” or “despair” level. In one experiment, such pre-emptive power up negated the need for the individual to ingest the happiness pills 408 or calmness pills 406 and ingested only the focus pills 402 and the willpower pills 404.

It will be appreciated that in one aspect the mindfulness ingestible device pills 402, 404, 406, 408 may be preprogrammed with respective tags for the focus pill 402, the willpower pill 404, the calmness pill 406, and the happiness pill 408 type IEM-enabled placebo pills. The preprogrammed mindfulness ingestible device pills 402, 404, 406, 408 can simply be ingested by the individual and the system to prompt behavior change 100 (FIG. 1) identifies the negative emotions the individual is attempting to control by reading the preprogrammed tag associated with the mindfulness ingestible device pills 402, 404, 406, 408.

In another aspect, the mindfulness ingestible device pills 402, 404, 406, 408 are not preprogrammed and are actually all the same placebo pill when packaged in the dispensing apparatus 400 to be labeled or assigned a meaning by the individual. In this configuration, the individual communicates which ingestible device pills 402, 404, 406, 408 were ingested to the system to prompt behavior change 100 (FIG. 1). This can be done by entering the corresponding information associated with the ingestible device pills 402, 404, 406, 408 in a data receiver/detector (e.g., a wearable electronic patch) or a mobile device.

Furthermore, although in the above examples, the ingestible device was described primarily as a “placebo,” the present disclosure is not limited in this context. Accordingly, it should be appreciated that the mindfulness ingestible device dispensing apparatuses 300, 400 may comprise placebos, active pharmaceutical agents, vitamins, either exclusively or in any combination thereof. In addition, the ingestible devices may be preprogrammed or un-programmed, without limitation.

Accordingly, aspects of the mindfulness methodology according to the present disclosure provide an effective technology for tracking the mood of the individual. The instant gratification that an individual receives from ingesting a mindfulness ingestible device, whether placebo or otherwise, provides the individual with instant incentive to keep monitoring how they feel, and the full suite of data gathered over time can help the individual make even more insightful discoveries and decisions. Accordingly, the mindfulness methodology technology becomes an effective feedback tool for the individual. Accordingly, the mindfulness methodology provides an effective feedback tool.

In other aspects, ingestion of mindfulness ingestible devices may be applied to monitor conditions beyond tracking negative moods. A diabetic individual, for example, may be able to employ the mindfulness methodology to track severe drops in energy or to design personal specific “enhancement” pills to help the individual get through specific challenges of which the individual would like to become more aware and more in control.

Additionally, there are also many ways that the individual can use the mindfulness methodology technology to make the feedback more powerful. For example, every time an individual ingests the happiness pill 408, the individual's mobile device can be configured with application software to contact the individual's social network to let other people know that the individual could use a call. In other aspects, the mobile phone can send a specific task when the individual is feeling in a negative mood, like go on a walk or cuddle with the neighbor's dog, for example.

There are also many ways the individual can use the mindfulness methodology technology to make the feedback more powerful. For example, every time the individual ingests the happiness pill 408, the individual's mobile phone can notify the individual's social network and let people know they could use a call. The mobile phone could be configured to send the individual a specific task when the individual is in a negative mood, would like to go on a walk, or cuddle with their neighbor's dog. Accordingly, the mindfulness methodology not only tracks the individual's mood, but also empowers the individual to improve their well being.

As described hereinabove, in various aspects, the mindfulness methodology may be employed not only to track the individual's mood, but also to empower the individual to improve his or her well-being. In this manner, a mindfulness methodology according to the present disclosure may do more than just provide the benefits of targeted mindfulness. Applications may be layered on top of the data to create more effective positive behavior changes, for example.

In one aspect, the mindfulness methodology according to the present disclosure, not only promotes behavior change but also provides two effects from swallowing the ingestible device: (1) the placebo or mindful effect and then (2) the system response. Accordingly, the individual swallows the ingestible device pills 402, 404, 406, 408 and causes an action response by the system 100. For example, when the individual swallows the pills, the system 100 automatically sends a tweet on Twitter, sends a Facebook “like,” sends an SMS or MMS message, and/or sends an email. In one aspect, each of these system 100 actions can be tied into a chain that might ultimately accomplish some desired action. In various aspects, such system 100 responses may create immense virility, e.g., where referring to any viral phenomenon where an object or pattern is able to induce some agents to replicate it, resulting in many copies being produced and spread around. This may be especially so if the automatic email messages generate responses such as, for example, a daily joke, love letter, or set of rewards points you send to others (e.g., taking meds rewards the individual's grandchildren).

### Mood Miner Mindfulness Methodology

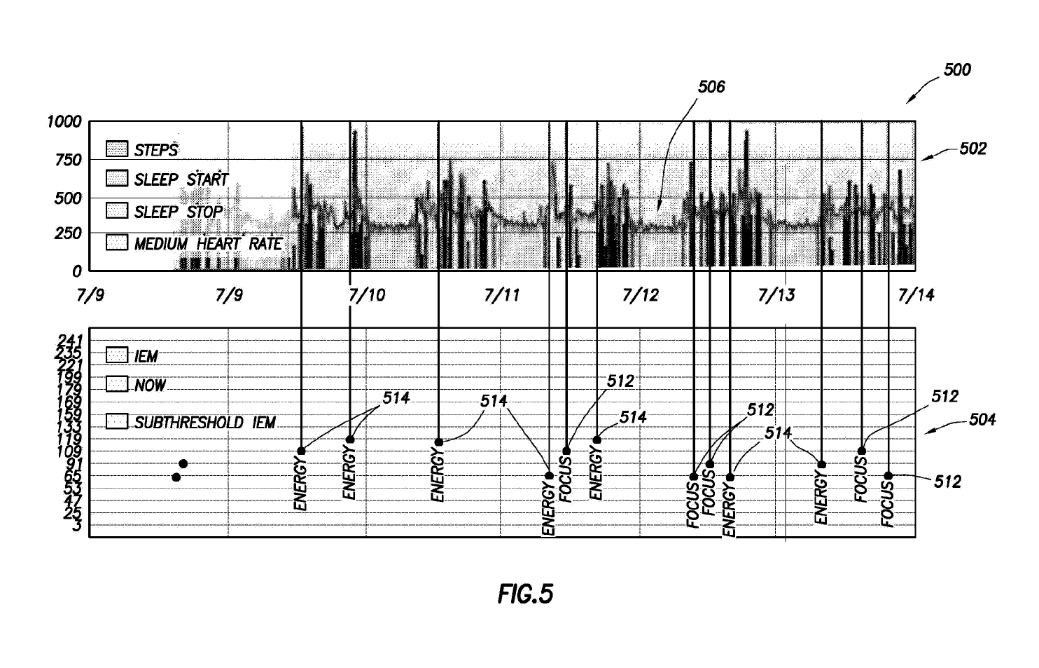

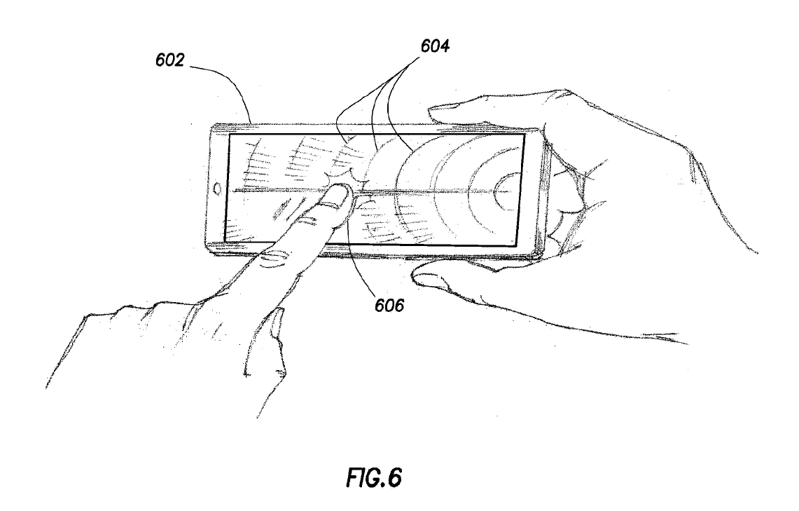

In one aspect, the mindfulness methodology may comprise a mood miner methodology, as illustrated in FIG. 6. In one aspect, the mood miner methodology aspect of the mindfulness methodology provides a system that collects objective measures as well as subjective inputs in a convenient way. The mood miner methodology identifies patterns and relationships between an individual's exercise, sleep, and medicine adherence with subjective inputs, making visible the relationships between them and making behavioral choices more relevant. Comparing longitudinal subjective input with objective body measures reveals surprising patterns that help correct intuitive theories about why the individual feels the way he does. Adjusting the individual's theories allows for stronger intrinsic motivators for better behavior.

Examples of implementation include generation of the mindfulness promotion data 102, e.g., sleep data, medication ingestion data, and exercise data and subjective data. Subjective data generation may be accomplished via various methods. In one example, an application on an individual's mobile phone 602 displays concentric rings 604 of varying colors. Each color is representative of the individual's relative feelings, emotions, self-assessment, etc. The individual selects a color 606 pertinent to the conditions and the application generates the subjective data. The mindfulness promotion data 102 are communicated to the individual's phone application, which has an associated methodology module. The methodology module 104 may process the data 102 to identify the corresponding mood miner methodology. The instruction module 106 may initiate an instruction whereby the program(s) 206 and associated system(s) analyze the data 102 for patterns and meaningfully display the patterns, related insights, etc.

Help from My Friends Mindfulness Methodology

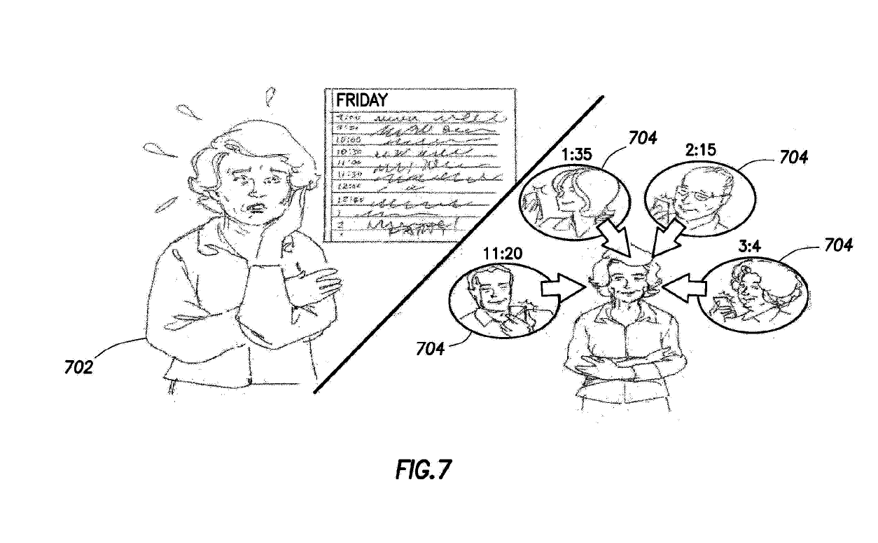

In one aspect, the mindfulness methodology may comprise a component where an individual 702 receives help from their friends 704. In one aspect, the help from my friends methodology, as conceptually illustrated in FIG. 7, provides a system that facilitates the engagement of support from an individual's personal network by, for example, taking medication with an ingestible device that marks an ingestion event. If the individual 702 feels that he or she needs (or might need) support, the individual 702 can swallow a pill that alerts the designated network to this fact through Twitter tweets, SMS or MMS messages, Facebook alerts or posts, emails, etc. The individual's friends/family members are then able to provide help, encouragements, or empathy. The automatic and effortless activation of a support network by ingesting an event marker helps individuals navigate through adherence rough spots and potentially prevents slipping.

Examples of implementation include generation of the mindfulness promotion data 102, e.g., medication event data. The mindfulness promotion data are communicated to a website associated with the methodology module. The methodology module 104 may process the mindfulness promotion data to identify the corresponding help from my friends methodology. The instruction module 106 may initiate an instruction whereby program(s) 206 and associated system(s) generate meaningful alerts, messages, etc.

### Commit to Healthy Eating Mindfulness Methodology

In one aspect, the mindfulness methodology may comprise a component where the individual commits to healthy eating. In one aspect, the commit to healthy eating methodology, as illustrated in FIG. 8, provides a system that encourages healthy eating habits through commitment pills and reminders. At the start of the day, an individual 802 takes pills, e.g., placebos, vitamins, etc., having an associated ingestible device that represents the individual's commitment to eating a certain number of vegetable or fruit servings and this commitment is noted on social media, e.g., her Facebook page, Twitter account, SMS or MMS message, email, and the like. As each mealtime arrives, her receiver/detector patch 804 vibrates to remind her of her commitment and upon acknowledging that she has eaten properly, the achievement is posted (celebrated) on her Facebook wall, send by way of tweet on Twitter, and SMS or MMS message, email, and the like as illustrated in 806, 808, and 810. By presenting commitments publicly, individuals feel more obligated to complete them. Additionally, planning healthy eating behaviors at the start of each day enables the individual 802 to become more mindful about diet.

### Matched Mindfulness Methodology

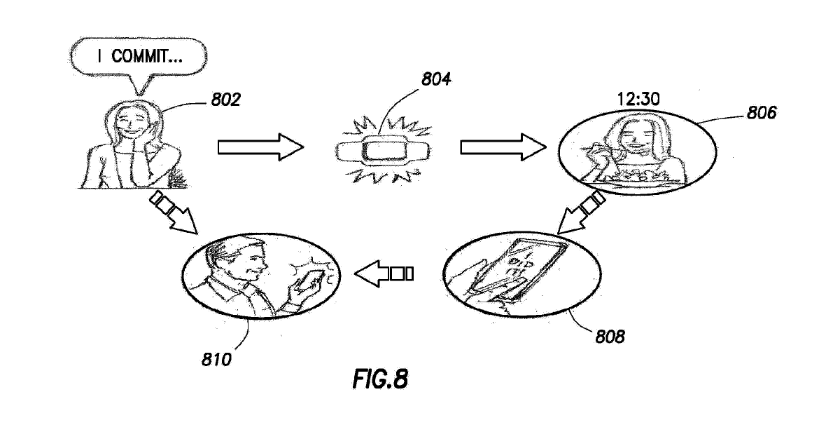

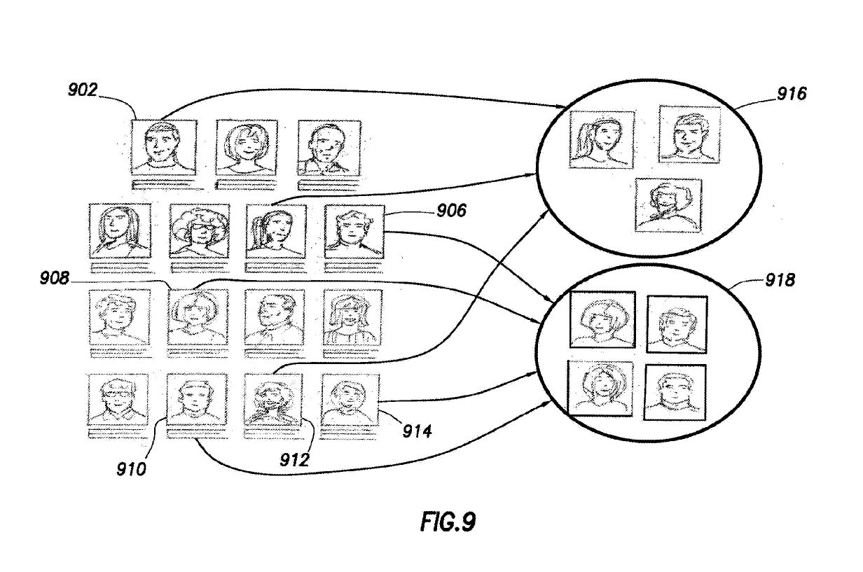

In one aspect, a matched methodology, as conceptually illustrated in FIG. 9, provides a system that selects people to form optimal support groups based on ailments, goals, needs, etc. Using information on individual's adherence to medication and fitness regimens as well as collected personality data, this system groups people with similar (or potentially complementary) support needs to form inspirational and relatable groups for maximum benefit. Offering individuals a meaningfully matched support group both increases the potential for the group to be effective, and possibly alleviates fears of joining a group with an unknown composition.

Examples of implementation include generation of the mindfulness promotion data 102, e.g., individual adherence data, etc. The mindfulness promotion data are communicated to a website associated with the methodology module 104 (FIG. 1). The methodology module 104 may process the mindfulness promotion data 102 to identify the corresponding matched methodology. The instruction module 106 may initiate an instruction whereby program(s) and associated system(s) match each individual 902, 904, 906, 908, 910, 912, 914 to a group of persons 916, 918 based on predetermined criteria, e.g., disease condition, fitness regimen, medication regimen, etc. and facilitate an online networking forum between support group members.

### Method

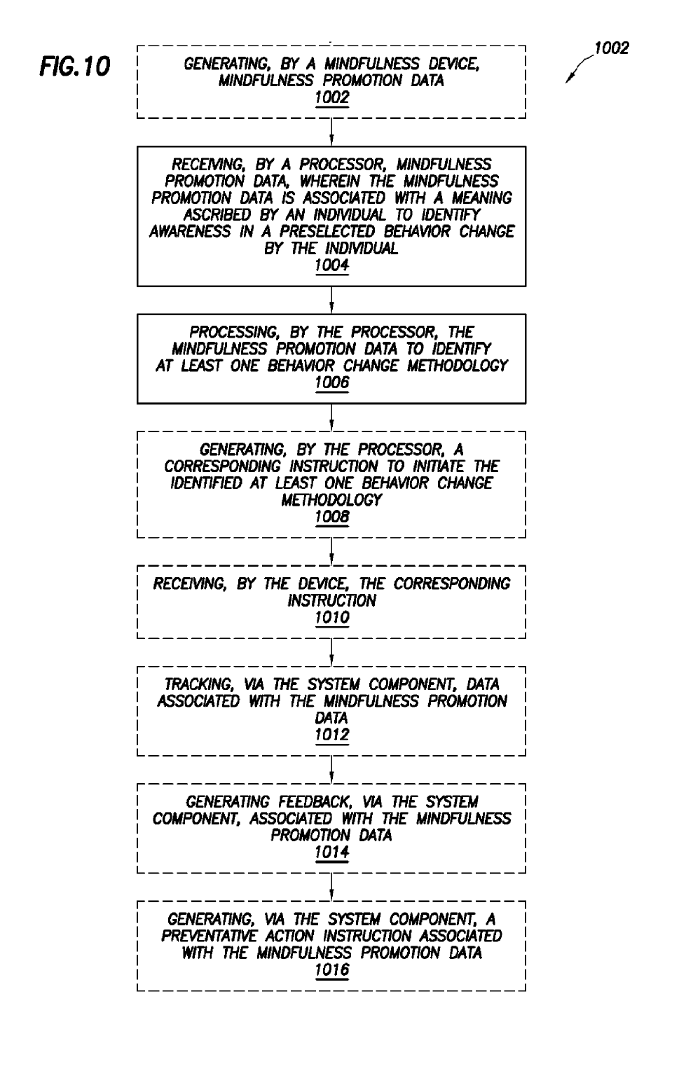

With reference now to FIG. 10, there is shown a method to prompt behavior change based on mindfulness 1000. In various aspects, the method may optionally (illustrated in phantom outline) comprise an initial step of generating, by a mindfulness-promotion device, mindfulness promotion data at step 1002. In various aspects, the method may comprise the following processes: at 1004 receiving, by a processor, mindfulness promotion data, wherein the mindfulness promotion data are associated with a meaning ascribed by an individual to identify awareness in a preselected behavior change by the individual; at 1006 processing, by the processor, the mindfulness promotion data to identify at least one preselected behavior change methodology; and at 1008 generating, by the processor, a corresponding instruction to initiate the identified at least one behavior change methodology. In various aspects, the method may optionally comprise one or more of the following processes: at 1010 receiving, by the device, the corresponding instruction; at 1012 tracking, via a system component, data associated with the mindfulness promotion data; at 1014 generating feedback, via the system component, associated with the mindfulness promotion data; and at 1016 generating, via the system component, a preventative action instruction associated with the mindfulness promotion data.

In various aspects, and as heretofore discussed, the mindfulness methodology according to the present disclosure may comprise data associated with various health-related events and combinations thereof, e.g., an ingestion event, an injection event, an inhalation event, an infusion event, a health monitoring event, an physical activity event, and an eating event. To illustrate, the mindfulness methodology data related to an ingestion event may be generated by an ingestible device such as an RFID-enabled device, a current-altering device, an IEM-enabled ingestible device, among other ingestible devices, for example.

The behavior change mindfulness methodologies include various examples of methodologies which function to prompt behavior, e.g., a desirable, sustainable behavior change associated with a health-related issue, event, regimen, etc.; to engender empathy, e.g., identify with a cause, garner family support, etc., which may prompt a behavior change, etc. The non-exhaustive list of examples previously discussed may be applied in various aspects of the method, e.g., a mindfulness methodology; a mood miner methodology; a help from my friends methodology; and a commit to healthy eating methodology. Preselection may be various modes, e.g., manual selection by a participant, automated selection, a combination thereof, etc.

The mindfulness methodology, for example, may incorporate or otherwise be associated with direct or indirect support of an individual or cause in need, an economic consequence, etc. In this example, the mindfulness methodology may empathize to the individual or cause in need to be aware and mindful in all activities and movements both physical and mental to motivated the individual to make and maintain a behavior change having a positive impact on a health-related outcome.

The mindfulness methodology may comprise, but does not necessarily include, a verifiable transaction, e.g., computer-generated feedback to the donor and other interested parties; a quantifiable donation, e.g., two pills donated for every pill ingested by the donor, etc.

### Article

In various aspects, an article may comprise a non-transitory storage medium having instructions, that when executed by a computing platform, result in execution of a method of communicating mindfulness promotion data via a network, comprising/consisting of: receiving, via a hub, the mindfulness promotion data; communicating, via the hub, at least a portion of the mindfulness promotion data to a methodology module; identifying, via a methodology module, at least one methodology associated with the health promotion data; and generating, via an instruction module, at least one instruction associated with the identified methodology.

The article may further comprise one or more of the following processes: tracking, via a component of the network, data associated with the mindfulness promotion data based on a mindfulness methodology; generating, via a component of the network, data associated with the mindfulness promotion data based on a mindfulness methodology; and generating, via a component of the network, a preventative action instruction associated with the mindfulness promotion data based on a mindfulness methodology.

Any of the aspects disclosed herein may be performed in a data processing system or by a data processing method, e.g., instructional steps carried out by a computer, processor, etc. To illustrate, a diagrammatic system comprises, for example, a processor, a main memory, a static memory, a bus, a video display, an alpha-numeric input device, a cursor control device, a drive unit, a signal generation device, a network interface device, a machine readable medium, instructions and a network, according to one embodiment.

The diagrammatic system may indicate a personal computer and/or a data processing system in which one or more operations disclosed herein may be performed. The processor may be a microprocessor, a state machine, an application-specific integrated circuit, a field programmable gate array, etc. The main memory may be a dynamic random access memory and/or a primary memory of a computer system. The static memory may be a hard drive, a flash drive, and/or other memory information associated with the data processing system.

The bus may be an interconnection between various circuits and/or structures of the data processing system. The video display may provide graphical representation of information on the data processing system. The alpha-numeric input device may be a keypad, a keyboard and/or any other input device of text, e.g., a special device to aid the physically challenged. The cursor control device may be a pointing device such as a mouse. The drive unit may be a hard drive, a storage system, and/or other longer term storage subsystem. The signal generation device may be a bios and/or a functional operating system of the data processing system. The network interface device may be a device that may perform interface functions such as code conversion, protocol conversion and/or buffering required for communication to and from the network. The machine readable medium may provide instructions on which any of the methods disclosed herein may be performed. The instructions may provide source code and/or data code to the processor to enable any one/or more operations disclosed herein.

Although the present aspects have been described with reference to specific examples, it will be evident that various modifications and changes may be made to these aspects without departing from the broader spirit and scope of the various embodiments. For example, the various devices, modules, etc. described herein may be enabled and operated using hardware circuitry, e.g., CMOS based logic circuitry, firmware, software and/or any combination of hardware, firmware, and/or software, e.g., embodied in a machine readable medium.

For example, the various electrical structure and methods may be embodied using transistors, logic gates, and electrical circuits, e.g., Application Specific Integrated circuitry (ASIC) and/or in Digital Signal Processor (DSP) circuitry. For example, the receive module and the communicate module and other modules may be enabled using one or more of the technologies described herein.

In addition, it will be appreciated that the various operations, processes, and methods disclosed herein may be embodied in a machine-readable medium and/or a machine accessible medium compatible with a data processing system, e.g., a computer system, and may be performed in any order. Accordingly, the specification and drawings are to be regarded in an illustrative rather than a restrictive sense.

Any or all data associated with the aforementioned devices and methods, for example, may be used alone or in combination with other data to constitute mindfulness promotion data, e.g., data having a mindfulness promotion aspect.

In certain embodiments, the system and/or method steps further includes/utilizes an element for storing data, e.g., a data storage element, where this element is present on an external device, such as a bedside monitor, PDA, smart phone, computer server, etc. Typically, the data storage element is a computer readable medium. The term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on a computer readable medium, where “storing” means recording information such that it is accessible and retrievable at a later data by a computer and/or computer-related component. With respect to computer readable media, “permanent memory” refers to memory that is permanent. Permanent memory is not erased by termination of the electrical supply to a computer of processor. Computer hard-drive ROM, e.g., not used as virtual memory, CD-ROM, floppy disk and DVD are all examples of permanent memory. Random Access Memory (RAM) is an example of non-permanent memory. A file in permanent memory may be editable and re-writable.

Aspects extend to any manner of reading and monitoring the sensed parameters of medication and non-medication taking, administration and/or delivery, e.g., an adhesive sensor patch, other wearable sensors, device implants and insertables, parenteral medication delivery devices, mobile phones, etc., and devices to display and manage such information (computers, mobile phones, etc).

Further, various aspects may include one or more data fusion functions. As used herein, the term “data fusion” refers to a process, function, occurrence, event, etc. of data integration, e.g., combining of data, coupled with a reduction, replacement, analysis or other such data manipulation or change that brings about an improved result with respect to the combined data. Examples of improved results include combination of mindfulness promotion data and data resulting from one or more of the previously described methodologies from which, when analyzed, a reasonable inference may be drawn that an individual associated with the mindfulness promotion data has changed behavior patterns, resulting in improved adherence outcome(s).

Also provided are computer executable instructions, e.g., programming, for performing the above methods, e.g., for programming the IEM, receiver, and other components of the system. The computer executable instructions are present on a computer readable medium. Accordingly, various aspects provide a computer readable medium containing programming for use in providing ingestible event marker data.

As such, in certain embodiments the systems include one or more of: a data storage element, a data processing element, a data display element, a data transmission element, a notification mechanism, and an individual interface. These elements may be present or otherwise associated with at least one of mindfulness data, the hub, and the data systems.

One of the above-described systems is reviewed in terms of a receive module and a communicate module. The aspects, however, are not so limited. In a broader sense, the systems are composed of two or more different modules that communicate with each other, e.g., using the hub functionalities as reviewed above, e.g., using the mindfulness data in the communication, e.g., using the data systems' functionalities.

Various enabling aspects of the IEM are illustrated in FIGS. 11-15 below. It is appreciated that the IEM may be a system which comprises a partial power source that can be activated when in contact with conductive liquid and is capable of controlling conductance to mark an event. In the instance where the system is used with the product that is ingested by the living organism, when the product that includes the system is taken or ingested, the device comes into contact with the conducting liquid of the body. When the system of the present disclosure comes into contact with the body fluid, a voltage potential is created and the system is activated. A portion of the power source is provided by the device, while another portion of the power source is provided by the conducting fluid. That is, once ingested, the system comes into contact with body liquids and the system is activated. The system uses the voltage potential difference to power up and thereafter modulates conductance to create a unique and identifiable current signature. Upon activation, the system controls the conductance and, hence, current flow to produce the current signature.

With reference to FIG. 11, there is shown one aspect of an ingestible device event indicator system with dissimilar metals positioned on opposite ends as system 1130. The system 1130 can be used in association with any pharmaceutical product, as mentioned above, to determine when a patient takes the pharmaceutical product. As indicated above, the scope of the present disclosure is not limited by the environment and the product that is used with the system 1130. For example, the system 1130 may be placed within a capsule and the capsule is placed within the conducting liquid. The capsule would then dissolve over a period of time and release the system 1130 into the conducting liquid. Thus, in one aspect, the capsule would contain the system 1130 and no product. Such a capsule may then be used in any environment where a conducting liquid is present and with any product. For example, the capsule may be dropped into a container filled with jet fuel, salt water, tomato sauce, motor oil, or any similar product. Additionally, the capsule containing the system 1130 may be ingested at the same time that any pharmaceutical product is ingested in order to record the occurrence of the event, such as when the product was taken.

In the specific example of the system 1130 combined with the pharmaceutical product, as the product or pill is ingested, the system 1130 is activated. The system 1130 controls conductance to produce a unique current signature that is detected, thereby signifying that the pharmaceutical product has been taken. The system 1130 includes a framework 1132. The framework 1132 is a chassis for the system 1130 and multiple components are attached to, deposited upon, or secured to the framework 1132. In this aspect of the system 1130, a digestible material 1134 is physically associated with the framework 1132. The material 1134 may be chemically deposited on, evaporated onto, secured to, or built-up on the framework all of which may be referred to herein as “deposit” with respect to the framework 1132. The material 1134 is deposited on one side of the framework 1132. The materials of interest that can be used as the material 1134 include, but are not limited to: Cu or CuI. The material 1134 is deposited by physical vapor deposition, electrodeposition, or plasma deposition, among other protocols. The material 1134 may be from about 0.05 to about 500 .mu.m thick, such as from about 5 to about 100 .mu.m thick. The shape is controlled by shadow mask deposition, or photolithography and etching. Additionally, even though only one region is shown for depositing the material, each system 1130 may contain two or more electrically unique regions where the material 1134 may be deposited, as desired.

At a different side, which is the opposite side as shown in FIG. 11, another digestible material 1136 is deposited, such that materials 1134 and 1136 are dissimilar. Although not shown, the different side selected may be the side next to the side selected for the material 1134. The scope of the present disclosure is not limited by the side selected and the term “different side” can mean any of the multiple sides that are different from the first selected side. Furthermore, even though the shape of the system is shown as a square, the shape may be any geometrically suitable shape. Material 1134 and 1136 are selected such that they produce a voltage potential difference when the system 1130 is in contact with conducting liquid, such as body fluids. The materials of interest for material 1136 include, but are not limited to: Mg, Zn, or other electronegative metals. As indicated above with respect to the material 1134, the material 1136 may be chemically deposited on, evaporated onto, secured to, or built-up on the framework. Also, an adhesion layer may be necessary to help the material 1136 (as well as material 1134 when needed) to adhere to the framework 1132. Typical adhesion layers for the material 1136 are Ti, TiW, Cr or similar material. Anode material and the adhesion layer may be deposited by physical vapor deposition, electrodeposition or plasma deposition. The material 1136 may be from about 0.05 to about 500 .mu.m thick, such as from about 5 to about 100 .mu.m thick. However, the scope of the present disclosure is not limited by the thickness of any of the materials nor by the type of process used to deposit or secure the materials to the framework 1132.

Thus, when the system 1130 is in contact with the conducting liquid, a current path, an example is shown in FIG. 13, is formed through the conducting liquid between materials 1134 and 1136. A control device 1138 is secured to the framework 1132 and electrically coupled to the materials 1134 and 1136. The control device 1138 includes electronic circuitry, for example control logic that is capable of controlling and altering the conductance between the materials 1134 and 1136.

The voltage potential created between the materials 1134 and 1136 provides the power for operating the system as well as produces the current flow through the conducting fluid and the system. In one aspect, the system operates in direct current mode. In an alternative aspect, the system controls the direction of the current so that the direction of current is reversed in a cyclic manner, similar to alternating current. As the system reaches the conducting fluid or the electrolyte, where the fluid or electrolyte component is provided by a physiological fluid, e.g., stomach acid, the path for current flow between the materials 1134 and 1136 is completed external to the system 1130; the current path through the system 1130 is controlled by the control device 1138. Completion of the current path allows for the current to flow and in turn a receiver can detect the presence of the current and recognize that the system 1130 has been activated and the desired event is occurring or has occurred.

In one aspect, the two materials 1134 and 1136 are similar in function to the two electrodes needed for a direct current power source, such as a battery. The conducting liquid acts as the electrolyte needed to complete the power source. The completed power source described is defined by the physical chemical reaction between the materials 1134 and 1136 of the system 1130 and the surrounding fluids of the body. The completed power source may be viewed as a power source that exploits reverse electrolysis in an ionic or a conductive solution such as gastric fluid, blood, or other bodily fluids and some tissues. Additionally, the environment may be something other than a body and the liquid may be any conducting liquid. For example, the conducting fluid may be salt water or a metallic based paint.

In certain aspects, these two materials are shielded from the surrounding environment by an additional layer of material. Accordingly, when the shield is dissolved and the two dissimilar materials are exposed to the target site, a voltage potential is generated.

Referring again to FIG. 13, the materials 1134 and 1136 provide the voltage potential to activate the control device 1138. Once the control device 1138 is activated or powered up, the control device 1138 can alter conductance between the materials 1134 and 1136 in a unique manner. By altering the conductance between materials 1134 and 1136, the control device 1138 is capable of controlling the magnitude of the current through the conducting liquid that surrounds the system 1130. This produces a unique current signature that can be detected and measured by a receiver, which can be positioned internal or external to the body. In addition to controlling the magnitude of the current path between the materials, non-conducting materials, membrane, or “skirt” are used to increase the “length” of the current path and, hence, act to boost the conductance path, as disclosed in the U.S. patent application publication No. 2009-0082645 A1 entitled, “In-Body Device with Virtual Dipole Signal Amplification,” the entire content of which is incorporated herein by reference. Alternatively, throughout the disclosure herein, the terms “non-conducting material,” “membrane,” and “skirt” are interchangeably with the term “current path extender” without impacting the scope or the present aspects and the claims herein. The skirt, shown in portion at 1135 and 1137, respectively, may be associated with, e.g., secured to, the framework 1132. Various shapes and configurations for the skirt are contemplated as within the scope of the present disclosure. For example, the system 1130 may be surrounded entirely or partially by the skirt and the skirt maybe positioned along a central axis of the system 1130 or off-center relative to a central axis. Thus, the scope of the present disclosure as claimed herein is not limited by the shape or size of the skirt. Furthermore, in other aspects, the materials 1134 and 1136 may be separated by one skirt that is positioned in any defined region between the materials 1134 and 1136.

Referring now to FIG. 12, in another aspect of an ingestible device is shown in more detail as system 1140. The system 1140 includes a framework 1142. The framework 1142 is similar to the framework 1132 of FIG. 11. In this aspect of the system 1140, a digestible or dissolvable material 1144 is deposited on a portion of one side of the framework 1142. At a different portion of the same side of the framework 1142, another digestible material 1146 is deposited, such that materials 1144 and 1146 are dissimilar. More specifically, material 1144 and 1146 are selected such that they form a voltage potential difference when in contact with a conducting liquid, such as body fluids. Thus, when the system 1140 is in contact with and/or partially in contact with the conducting liquid, then a current path, an example is shown in FIG. 13, is formed through the conducting liquid between material 1144 and 1146. A control device 1148 is secured to the framework 1142 and electrically coupled to the materials 1144 and 1146. The control device 1148 includes electronic circuitry that is capable of controlling part of the conductance path between the materials 1144 and 1146. The materials 1144 and 1146 are separated by a non-conducting skirt 1149. Various examples of the skirt 1149 are disclosed in U.S. Provisional Application No. 61/173,511 filed on Apr. 28, 2009 and entitled “HIGHLY RELIABLE INGESTIBLE EVENT MARKERS AND METHODS OF USING SAME” and U.S. Provisional Application No. 61/173,564 filed on Apr. 28, 2009 and entitled “INGESTIBLE EVENT MARKERS HAVING SIGNAL AMPLIFIERS THAT COMPRISE AN ACTIVE AGENT”; as well as U.S. Patent Application Publication No. 2009-0082645 entitled “IN-BODY DEVICE WITH VIRTUAL DIPOLE SIGNAL AMPLIFICATION”; the entire disclosure of each is incorporated herein by reference.

Once the control device 1148 is activated or powered up, the control device 1148 can alter conductance between the materials 1144 and 1146. Thus, the control device 1148 is capable of controlling the magnitude of the current through the conducting liquid that surrounds the system 1140. As indicated above with respect to system 1130, a unique current signature that is associated with the system 1140 can be detected by a receiver to mark the activation of the system 1140. In order to increase the “length” of the current path the size of the skirt 1149 is altered. The longer the current path, the easier it may be for the receiver to detect the current.

Referring now to FIG. 13, the system 1130 of FIG. 11 is shown in an activated state and in contact with conducting liquid. The system 1130 is grounded through ground contact 1152. The system 1130 also includes a sensor module 1174, which is described in greater detail with respect to FIG. 15. Ion or current paths 1150 form between material 1134 to material 1136 through the conducting fluid in contact with the system 1130. The voltage potential created between the material 1134 and 1136 is created through chemical reactions between materials 1134/1136 and the conducting fluid.

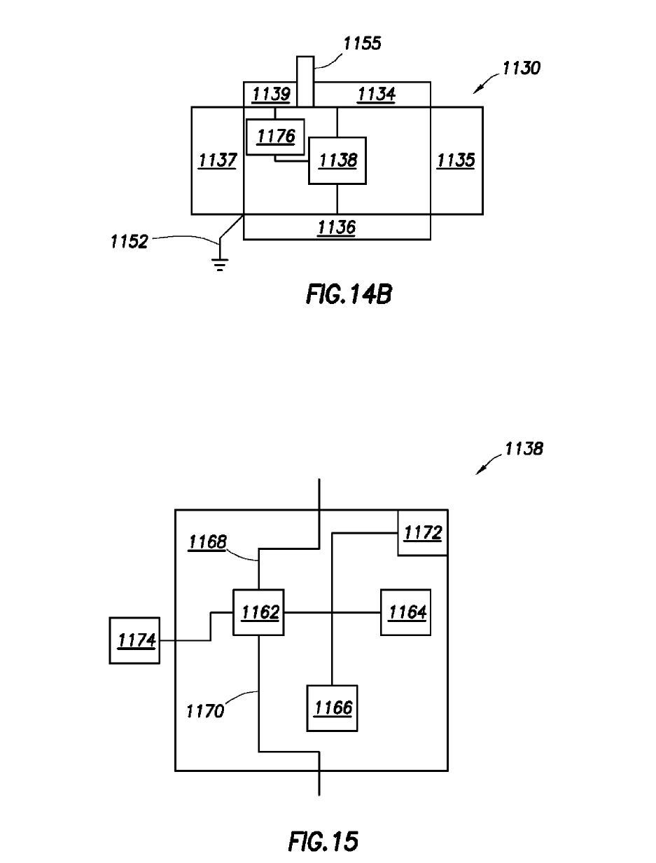

FIG. 14A shows an exploded view of the surface of the material 1134. The surface of the material 1134 is not planar, but rather an irregular surface 1154 as shown. The irregular surface 1154 increases the surface area of the material and, hence, the area that comes in contact with the conducting fluid.

In one aspect, at the surface of the material 1134, there is chemical reaction between the material 1134 and the surrounding conducting fluid such that mass is released into the conducting fluid. The term “mass” as used herein refers to protons and neutrons that form a substance. One example includes the instant where the material is CuCl and when in contact with the conducting fluid, CuCl becomes Cu (solid) and Cl.sup.- in solution. The flow of ions into the conduction fluid is depicted by the ion paths 1150. In a similar manner, there is a chemical reaction between the material 1136 and the surrounding conducting fluid and ions are captured by the material 1136. The release of ions at the material 1134 and capture of ion by the material 1136 is collectively referred to as the ionic exchange. The rate of ionic exchange and, hence the ionic emission rate or flow, is controlled by the control device 1138. The control device 1138 can increase or decrease the rate of ion flow by altering the conductance, which alters the impedance, between the materials 1134 and 1136. Through controlling the ion exchange, the system 1130 can encode information in the ionic exchange process. Thus, the system 1130 uses ionic emission to encode information in the ionic exchange.

The control device 1138 can vary the duration of a fixed ionic exchange rate or current flow magnitude while keeping the rate or magnitude near constant, similar to when the frequency is modulated and the amplitude is constant. Also, the control device 1138 can vary the level of the ionic exchange rate or the magnitude of the current flow while keeping the duration near constant. Thus, using various combinations of changes in duration and altering the rate or magnitude, the control device 1138 encodes information in the current flow or the ionic exchange. For example, the control device 1138 may use, but is not limited to any of the following techniques namely, Binary Phase-Shift Keying (PSK), Frequency modulation, Amplitude modulation, on-off keying, and PSK with on-off keying.

As indicated above, the various aspects disclosed herein, such as systems 1130 and 1140 of FIGS. 11 and 12, respectively, include electronic components as part of the control device 1138 or the control device 1148. Components that may be present include but are not limited to: logic and/or memory elements, an integrated circuit, an inductor, a resistor, and sensors for measuring various parameters. Each component may be secured to the framework and/or to another component. The components on the surface of the support may be laid out in any convenient configuration. Where two or more components are present on the surface of the solid support, interconnects may be provided.

As indicated above, the system, such as system 1130 and 1140, controls the conductance between the dissimilar materials and, hence, the rate of ionic exchange or the current flow. Through altering the conductance in a specific manner the system is capable of encoding information in the ionic exchange and the current signature. The ionic exchange or the current signature is used to uniquely identify the specific system. Additionally, the systems 1130 and 1140 are capable of producing various different unique exchanges or signatures and, thus, provide additional information. For example, a second current signature based on a second conductance alteration pattern may be used to provide additional information, which information may be related to the physical environment. To further illustrate, a first current signature may be a very low current state that maintains an oscillator on the chip and a second current signature may be a current state at least a factor of ten higher than the current state associated with the first current signature.

Referring now to FIG. 15, a block diagram representation of the control device 1138 is shown. The device 1138 includes a control module 1162, a counter or clock 1164, and a memory 1166. Additionally, the device 1138 is shown to include a sensor module 1172 as well as the sensor module 1174, which was referenced in FIG. 13. The control module 1162 has an input 1168 electrically coupled to the material 1134 and an output 1170 electrically coupled to the material 1136. The control module 1162, the clock 1164, the memory 1166, and the sensor modules 1172/1174 also have power inputs (some not shown). The power for each of these components is supplied by the voltage potential produced by the chemical reaction between materials 1134 and 1136 and the conducting fluid, when the system 1130 is in contact with the conducting fluid. The control module 1162 controls the conductance through logic that alters the overall impedance of the system 1130. The control module 1162 is electrically coupled to the clock 1164. The clock 1164 provides a clock cycle to the control module 1162. Based upon the programmed characteristics of the control module 1162, when a set number of clock cycles have passed, the control module 1162 alters the conductance characteristics between materials 1134 and 1136. This cycle is repeated and thereby the control device 1138 produces a unique current signature characteristic. The control module 1162 is also electrically coupled to the memory 1166. Both the clock 1164 and the memory 1166 are powered by the voltage potential created between the materials 1134 and 1136.

The control module 1162 is also electrically coupled to and in communication with the sensor modules 1172 and 1174. In the aspect shown, the sensor module 1172 is part of the control device 1138 and the sensor module 1174 is a separate component. In alternative aspects, either one of the sensor modules 1172 and 1174 can be used without the other and the scope of the present disclosure is not limited by the structural or functional location of the sensor modules 1172 or 1174. Additionally, any component of the system 1130 may be functionally or structurally moved, combined, or repositioned without limiting the scope of the present disclosure as claimed. Thus, it is possible to have one single structure, for example a processor, which is designed to perform the functions of all of the following modules: the control module 1162, the clock 1164, the memory 1166, and the sensor module 1172 or 1174. On the other hand, it is also within the scope of the present disclosure to have each of these functional components located in independent structures that are linked electrically and able to communicate.

Referring again to FIG. 15, the sensor modules 1172 or 1174 can include any of the following sensors: temperature, pressure, pH level, and conductivity. In one aspect, the sensor modules 1172 or 1174 gather information from the environment and communicate the analog information to the control module 1162. The control module then converts the analog information to digital information and the digital information is encoded in the current flow or the rate of the transfer of mass that produces the ionic flow. In another aspect, the sensor modules 1172 or 1174 gather information from the environment and convert the analog information to digital information and then communicate the digital information to control module 1162. In the aspect shown in FIG. 13, the sensor modules 1174 is shown as being electrically coupled to the material 1134 and 1136 as well as the control device 1138. In another aspect, as shown in FIG. 15, the sensor module 1174 is electrically coupled to the control device 1138 at a connection. The connection acts as both a source for power supply to the sensor module 1174 and a communication channel between the sensor module 1174 and the control device 1138.

Referring now to FIG. 14B, the system 1130 includes a pH sensor module 1176 connected to a material 1139, which is selected in accordance with the specific type of sensing function being performed. The pH sensor module 1176 is also connected to the control device 1138. The material 1139 is electrically isolated from the material 1134 by a non-conductive barrier 1155. In one aspect, the material 1139 is platinum. In operation, the pH sensor module 1176 uses the voltage potential difference between the materials 1134/1136. The pH sensor module 1176 measures the voltage potential difference between the material 1134 and the material 1139 and records that value for later comparison. The pH sensor module 1176 also measures the voltage potential difference between the material 1139 and the material 1136 and records that value for later comparison. The pH sensor module 1176 calculates the pH level of the surrounding environment using the voltage potential values. The pH sensor module 1176 provides that information to the control device 1138. The control device 1138 varies the rate of the transfer of mass that produces the ionic transfer and the current flow to encode the information relevant to the pH level in the ionic transfer, which can be detected by a receiver. Thus, the system 1130 can determine and provide the information related to the pH level to a source external to the environment.

As indicated above, the control device 1138 can be programmed in advance to output a pre-defined current signature. In another aspect, the system can include a receiver system that can receive programming information when the system is activated. In another aspect, the system can include a receiver system that can receive programming information when the system is activated. In another aspect, not shown, the switch 1164 and the memory 1166 can be combined into one device.

In addition to the above components, the system 1130 may also include one or other electronic components. Electrical components of interest include, but are not limited to: additional logic and/or memory elements, e.g., in the form of an integrated circuit; a power regulation device, e.g., battery, fuel cell or capacitor; a sensor, a stimulator, etc.; a signal transmission element, e.g., in the form of an antenna, electrode, coil, etc.; a passive element, e.g., an inductor, resistor, etc.

In addition, various enabling aspects of the receiver/detector are illustrated in FIGS. 16-21 below.

FIG. 16 provides a functional block diagram of how a receiver may implement a coherent demodulation protocol, according to one aspect of the disclosure. It should be noted that only a portion of the receiver is shown in FIG. 16. FIG. 16 illustrates the process of mixing the signal down to baseband once the carrier frequency (and carrier signal mixed down to carrier offset) is determined. A carrier signal 2221 is mixed with a second carrier signal 2222 at mixer 2223. A narrow low-pass filter 2220 is applied of appropriate bandwidth to reduce the effect of out-of-bound noise. Demodulation occurs at functional blocks 2225 in accordance with the coherent demodulation scheme of the present disclosure. The unwrapped phase 2230 of the complex signal is determined. An optional third mixer stage, in which the phase evolution is used to estimate the frequency differential between the calculated and real carrier frequency can be applied. The structure of the packet is then leveraged to determine the beginning of the coding region of the BPSK signal at block 2240. Mainly, the presence of the sync header, which appears as an FM porch in the amplitude signal of the complex demodulated signal is used to determine the starting bounds of the packet. Once the starting point of the packet is determined the signal is rotated at block 2250 on the IQ plane and standard bit identification and eventually decoded at block 2260.

In addition to demodulation, the transbody communication module may include a forward error correction module, which module provides additional gain to combat interference from other unwanted signals and noise. Forward error correction functional modules of interest include those described in PCT Application Serial No. PCT/US2007/024225 published as WO/2008/063626; the disclosure of which is herein incorporated by reference. In some instances, the forward error correction module may employ any convenient protocol, such as Reed-Solomon, Golay, Hamming, BCH, and Turbo protocols to identify and correct (within bounds) decoding errors.

Receivers of the disclosure may further employ a beacon functionality module. In various aspects, the beacon switching module may employ one or more of the following: a beacon wakeup module, a beacon signal module, a wave/frequency module, a multiple frequency module, and a modulated signal module.

The beacon switching module may be associated with beacon communications, e.g., a beacon communication channel, a beacon protocol, etc. For the purpose of the present disclosure, beacons are typically signals sent either as part of a message or to augment a message (sometimes referred to herein as “beacon signals”). The beacons may have well-defined characteristics, such as frequency. Beacons may be detected readily in noisy environments and may be used for a trigger to a sniff circuit, such as described below.

In one aspect, the beacon switching module may comprise the beacon wakeup module, having wakeup functionality. Wakeup functionality generally comprises the functionality to operate in high power modes only during specific times, e.g., short periods for specific purposes, to receive a signal, etc. An important consideration on a receiver portion of a system is that it be of low power. This feature may be advantageous in an implanted receiver, to provide for both small size and to preserve a long-functioning electrical supply from a battery. The beacon switching module enables these advantages by having the receiver operate in a high power mode for very limited periods of time. Short duty cycles of this kind can provide optimal system size and energy draw features.

In practice, the receiver may “wake up” periodically, and at low energy consumption, to perform a “sniff function” via, for example, a sniff circuit. For the purpose of the present application, the term “sniff function” generally refers to a short, low-power function to determine if a transmitter is present. If a transmitter signal is detected by the sniff function, the device may transition to a higher power communication decode mode. If a transmitter signal is not present, the receiver may return, e.g., immediately return, to sleep mode. In this manner, energy is conserved during relatively long periods when a transmitter signal is not present, while high-power capabilities remain available for efficient decode mode operations during the relatively few periods when a transmit signal is present. Several modes, and combination thereof, may be available for operating the sniff circuit. By matching the needs of a particular system to the sniff circuit configuration, an optimized system may be achieved.

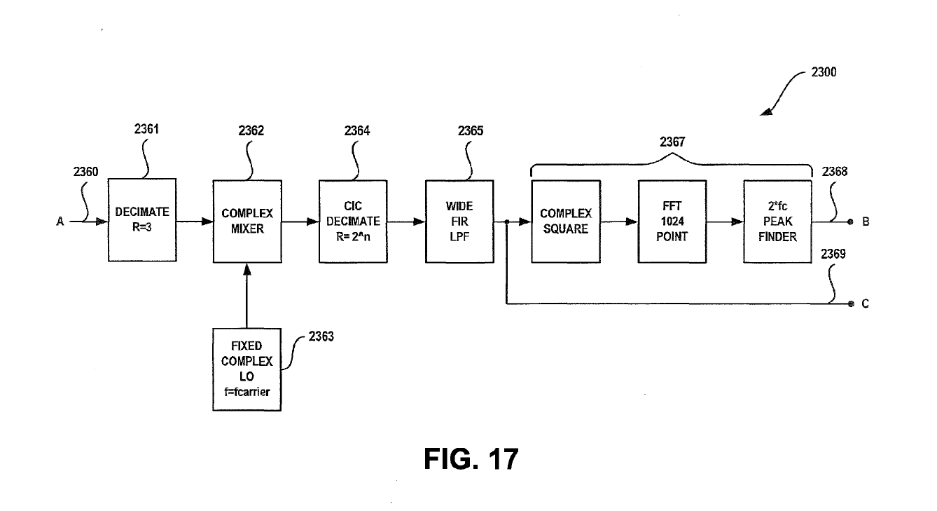

Another view of a beacon module 2300 is provided in the functional block diagram 2300 shown in FIG. 17. The scheme outlined in FIG. 17 outlines one technique for identifying a valid beacon. The incoming signal 2360 represents the signals received by electrodes, bandpass filtered (such as from 10 KHz to 34 KHz) by a high frequency signaling chain (which encompasses the carrier frequency), and converted from analog to digital. The signal 2360 is then decimated at block 2361 and mixed at the nominal drive frequency (such as, 12.5 KHz, 20 KHz, etc.) at mixer 2362. The resulting signal is decimated at block 2364 and low-pass filtered (such as 5 KHz BW) at block 2365 to produce the carrier signal mixed down to carrier offset—signal 2369. Signal 2369 is further processed by blocks 2367 (fast Fourier transform and then detection of two strongest peaks) to provide the true carrier frequency signal 2368. This protocol allows for accurate determination of the carrier frequency of the transmitted beacon.

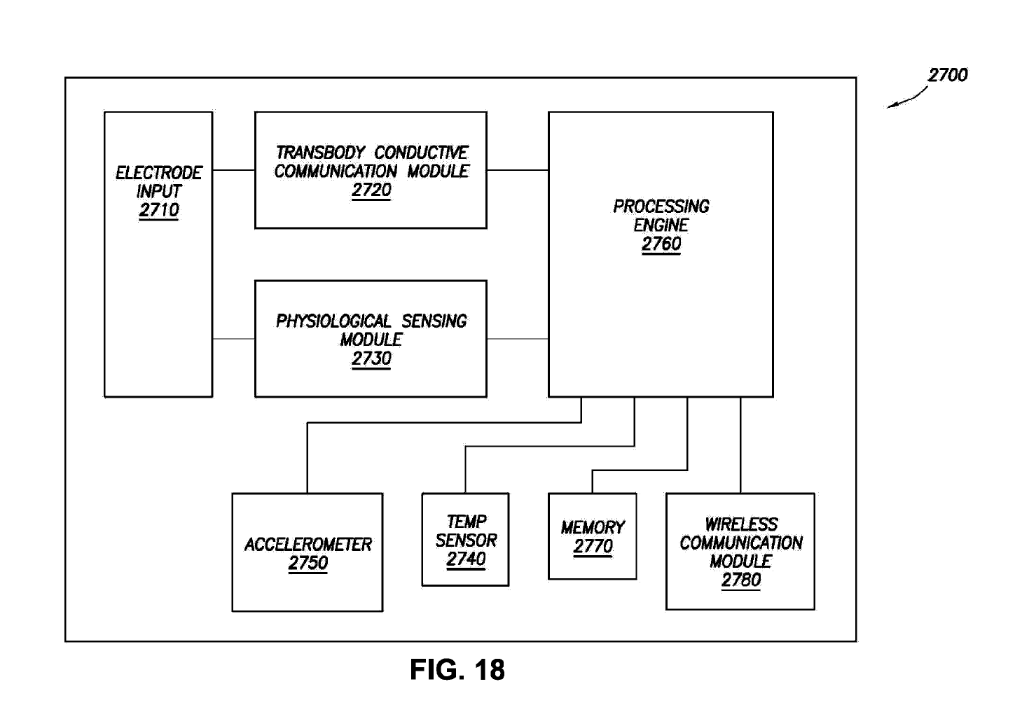

FIG. 18 provides a block functional diagram of an integrated circuit component of a signal receiver according to an aspect of the disclosure. In FIG. 18, a receiver 2700 includes electrode input 2710. Electrically coupled to the electrode input 2710 are transbody conductive communication module 2720 and physiological sensing module 2730. In one aspect, transbody conductive communication module 2720 is implemented as a high frequency (HF) signal chain and physiological sensing module 2730 is implemented as a low frequency (LF) signal chain. Also shown are CMOS temperature sensing module 2740 (for detecting ambient temperature) and a 3-axis accelerometer 2750. Receiver 2700 also includes a processing engine 2760 (for example, a microcontroller and digital signal processor), non-volatile memory 2770 (for data storage) and wireless communication module 2780 (for data transmission to another device, for example in a data upload action).

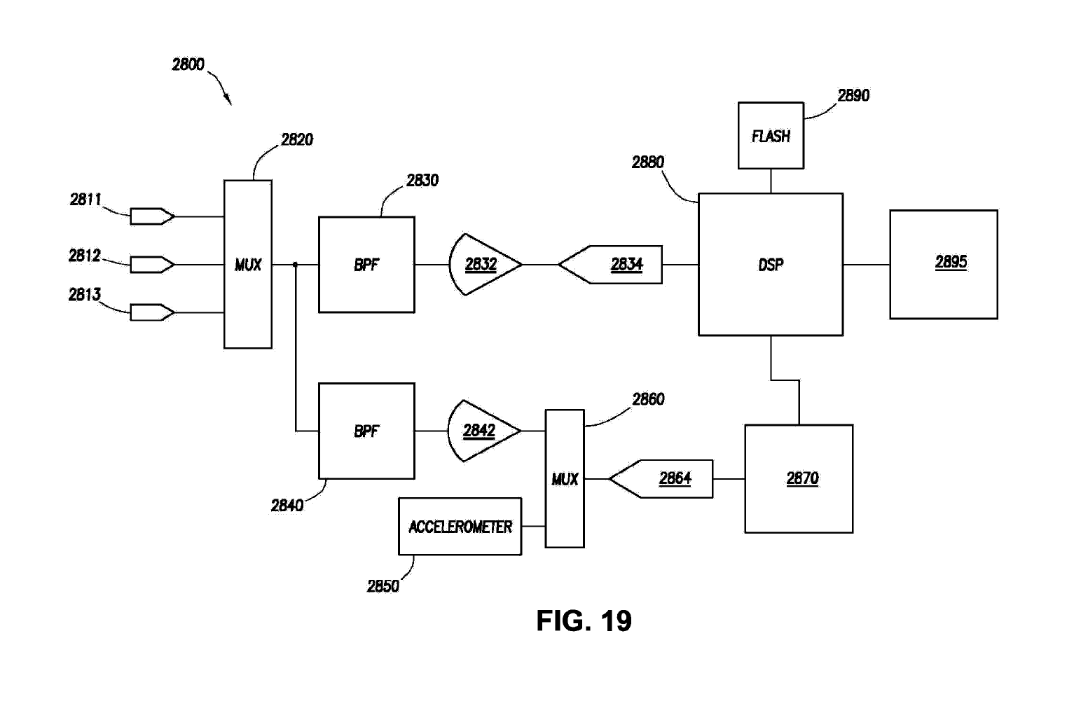

FIG. 19 provides a more detailed block diagram of a circuit configured to implement the block functional diagram of the receiver depicted in FIG. 18, according to one aspect of the disclosure. In FIG. 19, a receiver 2800 includes electrodes e1, e2 and e3 (2811, 2812 and 2813) which, for example, receive the conductively transmitted signals by an IEM and/or sense physiological parameters or biomarkers of interest. The signals received by the electrodes 2811, 2812, and 2813 are multiplexed by multiplexer 2820 which is electrically coupled to the electrodes.

Multiplexer 2820 is electrically coupled to both high band pass filter 2830 and low band pass filter 2840. The high and low frequency signal chains provide for programmable gain to cover the desired level or range. In this specific aspect, high band pass filter 2830 passes frequencies in the 10 KHz to 34 KHz band while filtering out noise from out-of-band frequencies. This high frequency band may vary, and may include, for example, a range of 3 KHz to 300 KHz. The passing frequencies are then amplified by amplifier 2832 before being converted into a digital signal by converter 2834 for input into high power processor 2880 (shown as a DSP) which is electrically coupled to the high frequency signal chain.

Low band pass filter 2840 is shown passing lower frequencies in the range of 0.5 Hz to 150 Hz while filtering out out-of-band frequencies. The frequency band may vary, and may include, for example, frequencies less than 300 Hz, such as less than 200 Hz, including less than 150 Hz. The passing frequency signals are amplified by amplifier 2842. Also shown is accelerometer 2850 electrically coupled to second multiplexer 2860. Multiplexer 2860 multiplexes the signals from the accelerometer with the amplified signals from amplifier 2842. The multiplexed signals are then converted to digital signals by converter 2864 which is also electrically coupled to low power processor (microcontroller) 2870.

In one aspect, a digital accelerometer (such as one manufactured by Analog Devices), may be implemented in place of accelerometer 2850. Various advantages may be achieved by using a digital accelerometer. For example, because the signals the digital accelerometer would produce signals already in digital format, the digital accelerometer could bypass converter 2864 and electrically couple to the low power microcontroller 2870—in which case multiplexer 2860 would no longer be required. Also, the digital signal may be configured to turn itself on when detecting motion, further conserving power. In addition, continuous step counting may be implemented. The digital accelerometer may include a FIFO buffer to help control the flow of data sent to the low power processor 2870. For instance, data may be buffered in the FIFO until full, at which time the processor may be triggered to turn awaken from an idle state and receive the data.

Low power processor 2870 may be, for example, an MSP430 microcontroller from Texas Instruments. Low power processor 2870 of receiver 2800 maintains the idle state, which as stated earlier, requires minimal current draw—e.g., 10 μA or less, or 1 μA or less.

High power processor 2880 may be, for example, a VC5509 digital signal process from Texas Instruments. The high power processor 2880 performs the signal processing actions during the active state. These actions, as stated earlier, require larger amounts of current than the idle state—e.g., currents of 30 μA or more, such as 50 μA or more—and may include, for example, actions such as scanning for conductively transmitted signals, processing conductively transmitted signals when received, obtaining and/or processing physiological data, etc.

The receiver may include a hardware accelerator module to process data signals. The hardware accelerator module may be implemented instead of, for example, a DSP. Being a more specialized computation unit, it performs aspects of the signal processing algorithm with fewer transistors (less cost and power) compared to the more general purpose DSP. The blocks of hardware may be used to “accelerate” the performance of important specific function(s). Some architectures for hardware accelerators may be “programmable” via microcode or VLIW assembly. In the course of use, their functions may be accessed by calls to function libraries.

The hardware accelerator (HWA) module comprises an HWA input block to receive an input signal that is to be processed and instructions for processing the input signal; and, an HWA processing block to process the input signal according to the received instructions and to generate a resulting output signal. The resulting output signal may be transmitted as needed by an HWA output block.

Also shown in FIG. 19 is flash memory 2890 electrically coupled to high power processor 2880. In one aspect, flash memory 2890 may be electrically coupled to low power processor 2870, which may provide for better power efficiency.

Wireless communication element 2895 is shown electrically coupled to high power processor 2880 and may include, for example, a BLUETOOTH™ wireless communication transceiver. In one aspect, wireless communication element 2895 is electrically coupled to high power processor 2880. In another aspect, wireless communication element 2895 is electrically coupled to high power processor 2880 and low power processor 2870. Furthermore, wireless communication element 2895 may be implemented to have its own power supply so that it may be turned on and off independently from other components of the receiver—e.g., by a microprocessor.

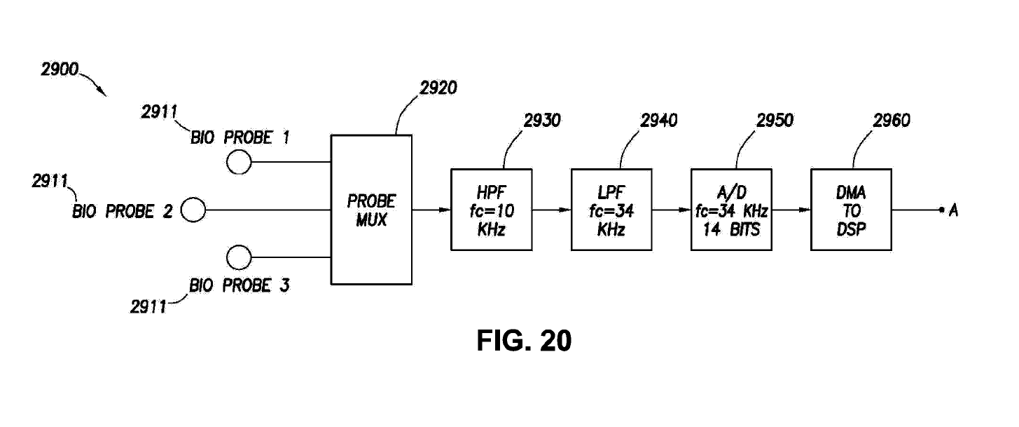

FIG. 20 provides a view of a block diagram of hardware in a receiver according to an aspect of the disclosure related to the high frequency signal chain. In FIG. 20, receiver 2900 includes receiver probes (for example in the form of electrodes 2911, 2912 and 2913) electrically coupled to multiplexer 2920. Also shown are high pass filter 2930 and low pass filter 2940 to provide for a band pass filter which eliminates any out-of-band frequencies. In the aspect shown, a band pass of 10 KHz to 34 KHz is provided to pass carrier signals falling within the frequency band. Example carrier frequencies may include, but are not limited to, 12.5 KHz and 20 KHz. One or more carriers may be present. In addition, receiver 2900 includes analog to digital converter 2950—for example, sampling at 500 KHz. The digital signal can thereafter be processed by the DSP. Shown in this aspect is DMA to DSP unit 2960 which sends the digital signal to dedicated memory for the DSP. The direct memory access provides the benefit of allowing the rest of the DSP to remain in a low power mode.

As stated earlier, for each receiver state, the high power functional block may be cycled between active and inactive states accordingly. Also, for each receiver state, various receiver elements (such as circuit blocks, power domains within processor, etc.) of a receiver may be configured to independently cycle from on and off by the power supply module. Therefore, the receiver may have different configurations for each state to achieve power efficiency.

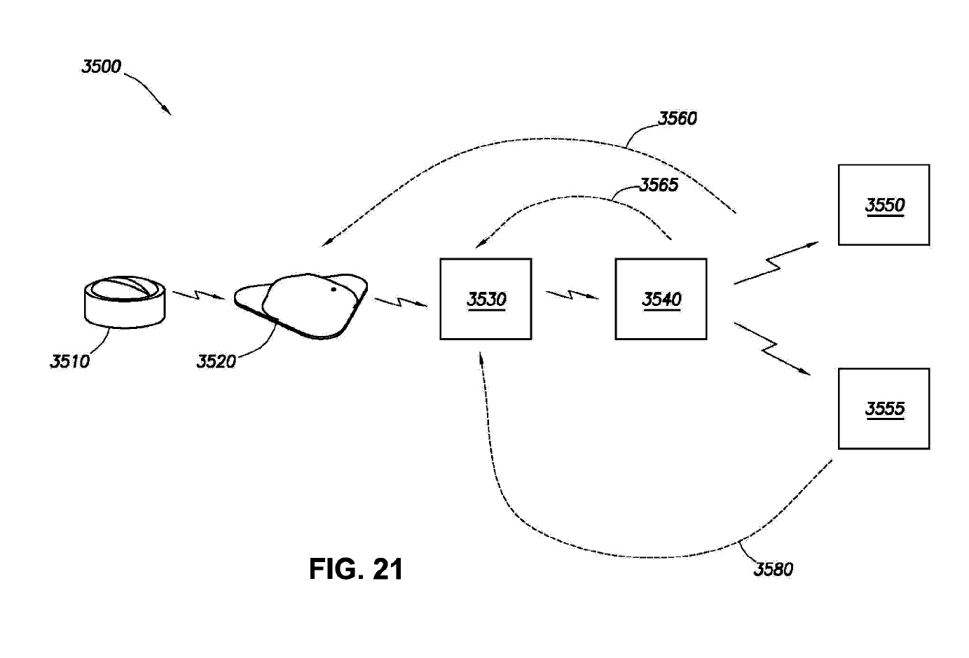

An example of a system of the disclosure is shown in FIG. 21. In FIG. 21, system 3500 includes a pharmaceutical composition 3510 that comprises an IEM. Also present in system 3500 is signal receiver 3520. Signal receiver 3520 is configured to detect a signal emitted from the identifier of the IEM 3510. Signal receiver 3520 also includes physiologic sensing capability, such as ECG and movement sensing capability. Signal receiver 3520 is configured to transmit data to a patient's an external device or PDA 3530 (such as a smart phone or other wireless communication enabled device), which in turn transmits the data to a server 3540. Server 3540 may be configured as desired, e.g., to provide for patient directed permissions. For example, server 3540 may be configured to allow a family caregiver 3550 to participate in the patient's therapeutic regimen, e.g., via an interface (such as a web interface) that allows the family caregiver 3550 to monitor alerts and trends generated by the server 3540, and provide support back to the patient, as indicated by arrow 3560. The server 3540 may also be configured to provide responses directly to the patient, e.g., in the form of patient alerts, patient incentives, etc., as indicated by arrow 3565 which are relayed to the patient via PDA 3530. Server 3540 may also interact with a health care professional (e.g., RN, physician) 3555, which can use data processing algorithms to obtain measures of patient health and compliance, e.g., wellness index summaries, alerts, cross-patient benchmarks, etc., and provide informed clinical communication and support back to the patient, as indicated by arrow 3580.

It is to be understood that this disclosure is not limited to particular embodiments described, and as such may vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods and materials are now described.

Notwithstanding the appended claims, the disclosure is also defined by the following clauses:

1. A method, comprising:

receiving, by a processor, mindfulness promotion data, wherein the mindfulness promotion data are associated with a meaning ascribed by an individual to identify awareness in a preselected behavior change by the individual;
processing, by the processor, the mindfulness promotion data to identify the at least one preselected behavior change methodology; and
generating, by the processor, a corresponding instruction to initiate the identified at least one preselected behavior change methodology.

2. The method of clause 1, wherein the mindfulness promotion data are generated from at least one event selected from a group consisting essentially of an ingestion event, an injection event, an inhalation event, an infusion event, a health monitoring event, a physical activity event, and an eating event.

3. The method of clause 2, wherein the ingestion event generating the mindfulness promotion data is facilitated via an ingestible device.

4. The method of clause 3, wherein the ingestible device is selected from a group consisting essentially of an RFID-enabled device and a current-altering device.

5. The method of clause 1, wherein the at least one behavior change methodology is selected from a group consisting essentially of a mindfulness methodology; a mood miner methodology; a help from my friends methodology; a commit to healthy eating methodology; a placebo pills methodology; and a matched methodology.

6. The method of clause 5, further comprising associating the mindfulness methodology with at least one physical or mental state of the individual.

7. The method of clause 6, further comprising associating the physical or mental state of the individual with at least one of focus, energy, calmness, and happiness.

8. The method of clause 7, wherein the physical or mental state states are associated with antidotes of negative emotions, wherein the focus state is associated with stress, the energy state is associated with willpower, the calmness state is associated with anger, and the happiness state is associated with sadness.

9. The method of clause 1, further comprising generating, by a mindfulness promotion device, the mindfulness promotion data.

10. The method of clause 9, wherein the mindfulness promotion device is an ingestible device.

11. The method of clause 1, further consisting receiving, by a device, the corresponding instruction.

12. The method of clause 1, further comprising:

tracking, via a system component, data associated with the mindfulness promotion data; and
generating feedback, via a system component, associated with the mindfulness promotion data.

13. The method of clause 1, further comprising generating, via a system component, a preventative action instruction associated with the mindfulness promotion data.

14. The method of clause 1, further comprising:

generating a message, via a system, in response to the mindfulness promotion data; and
sending, via the system, in response to the message, another message to any one of a social network account, a short message service message, a multi-media message service message, or an electronic mail associated with the individual.

15. A system, comprising:

mindfulness promotion data generated by a device;
a methodology module associated with a processor to identify at least one behavior change methodology associated with the mindfulness promotion data; and
an instruction module associated with the processor to initiate the identified at least one behavior change methodology.

16. The system of clause 15, further comprising a data device to at least one of generate the mindfulness promotion data and communicate the mindfulness promotion data.

17. The system of clause 16, wherein the data device is selected from a group consisting essentially of an ingestible device, an injection device, an inhalation device, an infusion device, a detector device, a health monitoring device, a physical activity device, an implantable device, a drug depot release device, and an eating device.

18. The system of clause 17, wherein the ingestible device encodes the mindfulness promotion data in a current flow.

19. The system of clause 18, wherein the ingestible device comprises:

a control device for altering conductance; and
a partial power source comprising:
a first material electrically coupled to the control device; and
a second material electrically coupled to the control device and electrically isolated from the first material;
wherein the first and second materials are selected to provide a voltage potential difference when in contact with a conducting liquid, and
wherein the control device alters the conductance between the first and second materials such that the magnitude of the current flow is varied to encode the mindfulness promotion data.

20. The system of clause 15, wherein the data device communicates at least one of medication delivery event data and physiologic parameter data.

21. The system of clause 15, further comprising a tracking/feedback module to at least one of track data associated with the mindfulness promotion data and generate feedback associated with the mindfulness promotion data.

22. The system of clause 15, further comprising a preventative action module to generate a preventative action instruction associated with the mindfulness promotion data.

23. An article comprising:

a non-transitory storage medium having instructions, that when executed by a computing platform, result in execution of a method of communicating mindfulness promotion data via a network, comprising:
receiving, via a hub, the mindfulness promotion data;
communicating, via the hub, at least a portion of the mindfulness promotion data to a methodology module;
identifying, via a methodology module, at least one methodology associated with the mindfulness promotion data; and
generating, via an instruction module, at least one instruction associated with the identified methodology.

24. The article of clause 23, further comprising at least one of the following steps of:

tracking, via a component of the network, data associated with the mindfulness promotion data; and
generating, via a component of the network, data associated with the mindfulness promotion data.

25. The article of clause 23, further comprising generating, via a component of the network, a preventative action instruction associated with the mindfulness promotion data.

26. A system, comprising:

mindfulness promotion data generated by a device;
a methodology module associated with a processor to identify at least one behavior change methodology associated with the mindfulness promotion data; and
an instruction module associated with the processor to initiate the identified at least one behavior change methodology,
wherein fusion of the mindfulness promotion data and data associated with the behavior change methodology directly or indirectly prompt a behavior change.

All applications, publications, and patents cited in this specification are herein incorporated by reference as if each individual publication or patent were specifically and individually indicated to be incorporated by reference and are incorporated herein by reference to disclose and describe the systems, methods and/or materials in connection with which they are cited. The citation of any publication is for its disclosure prior to the filing date and should not be construed as an admission that the present disclosure is not entitled to antedate such publication by virtue of prior disclosure. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

Although the foregoing disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the disclosure. It will be appreciated that those skilled in the art will be able to devise various arrangements which, although not explicitly described or shown herein, embody the principles of the disclosure and are included within its spirit and scope. Furthermore, all examples and conditional language recited herein are principally intended to aid the reader in understanding the principles of the disclosure and the concepts contributed by the inventors to furthering the art, and are to be construed as being without limitation to such specifically recited examples and conditions. Moreover, all statements herein reciting principles, aspects, and embodiments of the disclosure as well as specific examples thereof, are intended to encompass both structural and functional equivalents thereof. Additionally, it is intended that such equivalents include both currently known equivalents and equivalents developed in the future, e.g., any elements developed that perform the same function, regardless of structure. The scope of the present disclosure, therefore, is not intended to be limited to the exemplary embodiments shown and described herein. Rather, the scope and spirit of present disclosure is embodied by the appended claims.

What is claimed is:

1. A method, comprising:
receiving, by a processor, mindfulness promotion data, wherein the mindfulness promotion data are associated with a meaning ascribed by an individual to identify awareness in a preselected behavior change by the individual;
processing, by the processor, the mindfulness promotion data to identify the at least one preselected behavior change methodology; and
generating, by the processor, a corresponding instruction to initiate the identified at least one preselected behavior change methodology.

2. The method of claim 1, wherein the mindfulness promotion data are generated from at least one event selected from a group consisting essentially of an ingestion event, an injection event, an inhalation event, an infusion event, a health monitoring event, a physical activity event, and an eating event.

3. The method of claim 2, wherein the ingestion event generating the mindfulness promotion data is facilitated via an ingestible device.

4. The method of claim 3, wherein the ingestible device is selected from a group consisting essentially of an RFID-enabled device and a current-altering device.

5. The method of claim 1, wherein the at least one behavior change methodology is selected from a group consisting essentially of a mindfulness methodology; a mood miner methodology; a help from my friends methodology; a commit to healthy eating methodology; a placebo pills methodology; and a matched methodology.

6. The method of claim 5, further comprising associating the mindfulness methodology with at least one physical or mental state of the individual.

7. The method of claim 6, further comprising associating the physical or mental state of the individual with at least one of focus, energy, calmness, and happiness.

8. The method of claim 7, wherein the physical or mental state states are associated with antidotes of negative emotions, wherein the focus state is associated with stress, the energy state is associated with willpower, the calmness state is associated with anger, and the happiness state is associated with sadness.

9. The method of claim 1, further comprising generating, by a mindfulness promotion device, the mindfulness promotion data.

10. The method of claim 9, wherein the mindfulness promotion device is an ingestible device.

11. The method of claim 1, further consisting receiving, by a device, the corresponding instruction.

12. The method of claim 1, further comprising:
tracking, via a system component, data associated with the mindfulness promotion data; and
generating feedback, via a system component, associated with the mindfulness promotion data.

13. The method of claim 1, further comprising generating, via a system component, a preventative action instruction associated with the mindfulness promotion data.

14. The method of claim 1, further comprising:
generating a message, via a system, in response to the mindfulness promotion data; and
sending, via the system, in response to the message, another message to any one of a social network account, a short message service message, a multi-media message service message, or an electronic mail associated with the individual.

15. A system, comprising:
mindfulness promotion data generated by a device;
a methodology module associated with a processor to identify at least one behavior change methodology associated with the mindfulness promotion data; and
an instruction module associated with the processor to initiate the identified at least one behavior change methodology.

16. The system of claim 15, further comprising a data device to at least one of generate the mindfulness promotion data and communicate the mindfulness promotion data.

17. The system of claim 16, wherein the data device is selected from a group consisting essentially of an ingestible device, an injection device, an inhalation device, an infusion device, a detector device, a health monitoring device, a physical activity device, an implantable device, a drug depot release device, and an eating device.

18. The system of claim 17, wherein the ingestible device encodes the mindfulness promotion data in a current flow.

19. The system of claim 18, wherein the ingestible device comprises:
a control device for altering conductance; and
a partial power source comprising:
a first material electrically coupled to the control device; and
a second material electrically coupled to the control device and electrically isolated from the first material;
wherein the first and second materials are selected to provide a voltage potential difference when in contact with a conducting liquid, and
wherein the control device alters the conductance between the first and second materials such that the magnitude of the current flow is varied to encode the mindfulness promotion data.

20. The system of claim 15, wherein the data device communicates at least one of medication delivery event data and physiologic parameter data.

21. The system of claim 15, further comprising a tracking/feedback module to at least one of track data associated with the mindfulness promotion data and generate feedback associated with the mindfulness promotion data.

22. The system of claim 15, further comprising a preventative action module to generate a preventative action instruction associated with the mindfulness promotion data.

23. An article comprising:
a non-transitory storage medium having instructions, that when executed by a computing platform, result in execution of a method of communicating mindfulness promotion data via a network, comprising:
receiving, via a hub, the mindfulness promotion data;
communicating, via the hub, at least a portion of the mindfulness promotion data to a methodology module;
identifying, via a methodology module, at least one methodology associated with the mindfulness promotion data; and
generating, via an instruction module, at least one instruction associated with the identified methodology.

24. The article of claim 23, further comprising at least one of the following steps of:
tracking, via a component of the network, data associated with the mindfulness promotion data; and
generating, via a component of the network, data associated with the mindfulness promotion data.

25. The article of claim 23, further comprising generating, via a component of the network, a preventative action instruction associated with the mindfulness promotion data.

26. A system, comprising:
mindfulness promotion data generated by a device;
a methodology module associated with a processor to identify at least one behavior change methodology associated with the mindfulness promotion data; and
an instruction module associated with the processor to initiate the identified at least one behavior change methodology,
wherein fusion of the mindfulness promotion data and data associated with the behavior change methodology directly or indirectly prompt a behavior change.
